(19) United States
(12) Patent Application Publication
(10) Pub. No.: US 2018/0280219 A1
(43) Pub. Date: Oct. 4, 2018

(54) AIR MATTRESS TURNING DEVICE

(71) Applicant: ACCESS-ABLE DESIGNS, INC., VERO BEACH, FL (US)

(72) Inventors: ALLEN GARRETT, VERO BEACH, FL (US); RICKY WATKINS, VERO BEACH, FL (US)

(73) Assignee: ACCESS-ABLE DESIGNS, INC., VERO BEACH, FL (US)

(21) Appl. No.: 15/531,152

(22) PCT Filed: Nov. 27, 2015
(86) PCT No.: PCT/US15/62838

§ 371 Date: May 26, 2017

Related U.S. Application Data
(60) Provisional application No. 62/085,242, filed on Nov. 26, 2014.

(51) Int. Cl. A61G 7/057; A61G 7/00; A61G 7/10

(52) U.S. Cl. CPC A61G 7/05776; A61G 7/1021; A61G 7/001

(57) ABSTRACT

An apparatus for rotating a bed-ridden person in order to prevent pressure sores, or bed sores, comprising an first set of bladders and a second set of bladders, and at least one fluid pump, which may be an air pump, in fluid communication with the bladders through a system of fluid valves. Inflating first set of bladders will cause a patient to be rotated onto their right side; likewise, inflating the second set of bladders will cause a patient to be rotated onto their left side. A patient may therefore be rotated from left side to right side in order to prevent pressure, or bed, sores from occurring. The invention may be programmed to rotate persons automatically on any predetermined timing, and in any sequence, desired, or by manual command. The invention also comprises a pump and valve assembly for low pressure applications.

### CROSS REFERENCE TO RELATED APPLICATIONS

This is document is an international application for patent filed under the Patent Cooperation Treaty (PCT) in the United States Patent and Trademark Office Receiving Office (USPTO RO), claiming the benefit of U.S. provisional patent application Ser. No. 62/085,242 AIR MATTRESS TURNING DEVICE filed in the USPTO on Nov. 26, 2014, which is hereby incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

### 1. Field of the Invention

The field of the invention relates generally to devices and methods for moving and/or turning a person, such as a bed-ridden patient, while the person is disposed on a horizontal surface such as a mattress or bed in order to prevent the development or the exacerbation of bed sores or pressure sores. More specifically, the invention is directed to the field of inflatable apparatuses and methods using inflatable apparatuses for use in moving and/or turning a person, such as a bed-ridden patient, while the person is disposed on a horizontal surface such as a bed in order to prevent the development or the exacerbation of bed sores, pressure ulcers, pressure sores blood pooling or other types of physical conditions associated with poor blood circulation.

### 2. Background Art

It is well established in the medical arts that bed sores, also known as pressure sores or pressure ulcers, may develop when person, such as, for example, a disabled person or a medical patient, is required to lie in a supine position for extended periods of time. Bed sores may be caused by pressure or the compression of tissues and/or destruction of muscle cells of a person. In most cases, this compression is caused by the force of bone against a surface, as when a patient remains in a single decubitus position for a lengthy period. After an extended period of time with decreased tissue perfusion ischemia occurs and tissue necrosis may result if the affected tissue is left untreated. Bed sores may also be caused by shearing, a force created when the skin of a patient stays in one place as the deep fascia and skeletal muscle slide down with gravity, which can also cause the pinching off of blood vessels which may lead to ischemia and tissue necrosis. Friction is related to shear and may also cause bed sores. Bed sores may also be caused in part by the microclimate comprising temperature and moisture surrounding a portion of a person's skin that is in contact with the surface of the bed or wheelchair. Moisture on the skin may cause the skin to lose its dry outer layer and may reduce the tolerance of the skin for pressure and shear. This microclimate situation may be aggravated by other conditions such as excess moisture from incontinence, perspiration, or exudate. Over time, this excess moisture may cause the bonds between epithelial cells in a person's skin to weaken thus resulting in the maceration of the epidermis. Temperature may also be a very important contributing factor in the development of bed sores due to microclimate. Some studies have indicated that the cutaneous metabolic demand rises by 13% for every 1° C. rise in cutaneous temperature. When supply can't meet demand, ischemia may occur.

There are currently two major theories about the development of pressure ulcers. The first and most accepted is the deep tissue injury theory which asserts that the ulcers begin at the deepest level, around the bone, and move outward until they reach the epidermis. The second, less popular theory is the top-to-bottom model which asserts that skin first begins to deteriorate at the surface and then the deterioration proceeds inward.

People who are immobile are at highest risk of developing pressure ulcers. The risk of developing bedsores can be predicted by using the Braden scale for predicting pressure ulcer risk. The scale contains six areas of risk: cognitive-perceptual, immobility, inactivity, moisture, nutrition, and friction/shear. Nursing homes and hospitals may typically utilize various methods in order to avoid the development of pressure ulcers in bedridden patients, such as using a routine time frame for turning and repositioning to reduce pressure. The frequency of turning and repositioning depends on the level of risk in the patient. Turning patients every two hours has been a long-standing tradition, with little evidence to support its practice. Pressure-redistributive mattresses are used to reduce high values of pressure on prominent or bony areas of the body. Many support surfaces redistribute pressure by immersing and/or enveloping the body into the surface. Some support surfaces, including antidecubitus mattresses and cushions, contain multiple air chambers that are alternately pumped and emptied. However these systems of the prior art exhibit several serious drawbacks. First, these systems do not assist the person in turning and thus these persons must still seek help from an assistant, such as a nursing aid or other caregiver, in order to turn. Furthermore, these systems of the prior art comprise cells that are alternately filled and emptied of air, creating a soft surface upon which a person lies. This soft surface is sub-optimal for spinal health and can cause problems in the spine resulting in back pain and spinal misalignment, further aggravating the discomfort of the person who may be, for example, elderly or disabled. Still further, the systems of the prior art typically are not adaptable to be used in conjunction with an existing traditional mattress, and thus require expensive replacement of an entire mattress.

What is needed in the art, therefore, is an effective apparatus and method providing a supporting surface upon which a person, such as an elderly or disabled person, may lie that will also assist that person in turning in bed when desired without assistance from another person or other equipment, while allowing the user to utilize a mattress they have selected for that particular user's spine and back physiology. Such an apparatus and method would provide significant advancement in the state of the art, would prevent bed sores, would allow proper alignment of a user's spine while bed-ridden, and would allow a person using the apparatus and method of the invention to turn themselves as desired without needing assistance from another person. The present invention is also adapted to be used on top of a user's traditional mattress so that mattress replacement is not required and the user may continue use of the mattress of his or her choice. This allows a user to continue to use a mattress that may have been specifically selected for that particular user's spine and back physiology.

### BRIEF SUMMARY OF THE INVENTION

The present invention comprises an apparatus and method that have one or more of the following features and/or steps, which alone or in any combination may comprise patentable subject matter.

The present invention overcomes the shortcomings of the prior art in that it provides an economic, effective, pneumatically or hydraulically driven apparatus and method for turning a person in bed without assistance from another person or other equipment. The apparatus and method of the invention provide a significant advancement in the state of the art, prevent bed sores, allow proper alignment of a user's spine while bed-ridden, and allows a person using the apparatus and method of the invention to turn themselves as desired without needing assistance from another person. The present invention is adapted to be used on top of a user's traditional mattress so that mattress replacement is not required when using the apparatus and method of the invention, allowing the user to continue use of the mattress of his or her choice.

The invention comprises inflatable bladders that may be filled with a fluid such as compressed air in such a manner as to inflate, causing a user's body to be rotated from an initial, or supine or flat, position to either a first or second rotated position. When deflated, the bladders of the invention may remain disposed on a top surface of the user's mattress in a substantially flat configuration and allow the user to experience the firmness of the mattress while the user is resting. The bladders of the invention may comprise an number of bladders, but preferably comprises a first set of bladders comprising a pair of left side bladders and a second set of bladders comprising a pair of right side bladders which are independently inflatable, or, alternatively, may be configured so that the left side or right side bladders are independently inflatable in pairs; in other words, the left side bladders, comprising a first set of bladders, are inflated together independently from the right side bladders, and the right side bladders, comprising a second set of bladders, are inflatable together as a pair and are independently inflatable from the first, or left side, set of bladders. When it is desired to turn a user, it is first determined in which direction rotation of the user is desired. The bladders upon the opposite side of the mattress are then inflated, lifting the user and rotating the user's body onto the opposing side of the mattress. The bladders upon the side of the mattress upon which the user was originally lying may then be deflated. The process may be repeated in reverse when it is desired to turn the user back on to the side of the mattress upon which the user was originally lying. In this manner, the user may be turned from one side of a mattress to an opposing side of the mattress and vice versa, as desired. The first set of bladders and second set of bladders are disposed adjacent to one another, and the person to be rotated is initially positioned on the bladders when they are in a flat state, with a portion of the person's body disposed on the first set of bladders, and a portion of the person's body disposed on the second set of bladders.

In a first embodiment, the invention comprises a first set of inflatable bladders and a second set of inflatable bladders, each set of bladders comprising one or more inflatable bladders in fluid communication with at least one controllable fluid pump through a controllable fluid valve that is controllable to enable or disable fluid communication with the fluid pump. Each set of bladders is inflatable by pumping fluid into the at least one bladder comprising the set of bladders, and each set of bladders is also deflatable by pumping fluid out of the at least one bladder comprising the set of bladders, by operating the valves and at least one fluid pump.

In a further embodiment, the at least one fluid pump and fluid valves of the invention further comprise a pump and valve assembly that comprises a single fluid pump. The fluid pump and valve assembly may comprise a housing forming two plenums, and may further comprise three fluid diverter valves, in which first diverter valve is in fluid communication with the first set of bladders, the second diverter valve is in communication with the environment exterior to the pump and valve assembly (in other words, outside the enclosure), and the third fluid diverter valve is in fluid communication with the second set of bladders.

In any embodiment, the fluid may be a gas or liquid. In a preferred embodiment, the fluid is air. In any embodiment, it is preferable, but not necessary, that the pressure within any inflated bladder be maintained at between 0.7 pounds per square inch (p.s.i.) and 1.0 pounds per square inch relative to air pressure outside the bladder.

In any embodiment, the fluid pump(s) and valves may be controlled by a processor in electrical communication with the fluid pump(s) and valves.

In any embodiment, the processor may in wired or wireless communication with an external controller for allowing a user to input commands for controlling the pump(s) and valves of the invention.

In any embodiment, the processor may be in electrical communication with a computer readable media, such as solid state, magnetic or other media, in which computer readable non-transitory instructions are stored. The computer readable non-transitory instructions may be read from the computer readable media and used by the processor for controlling the fluid pump(s) and valves.

In any embodiment, a user may manually input commands, or the processor may execute computer readable instructions, for causing the pump(s) and valves of the invention to inflate the first set of bladders while deflating the second set of bladders, thus turning a user lying upon the invention in a first direction; and likewise the processor may execute computer readable instructions for causing the pump(s) and valves of the invention to inflate the first set of bladders while deflating the second set of bladders, thus turning a person lying upon the invention in a second direction. The turning of a person in the first direction and second direction may be programmed to occur automatically, at predetermined times, without interaction from the person except for the initial entering of commands to set the times for turning and initiating operation.

The bladders of the invention are inflatable bladders having an interior volume. The bladders may be inflated by motivating fluid, for instance air, into the interior volume of the bladder. The material comprising the bladder may be any flexible material, for example rubber.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1a depicts a view of the inflatable bladders of an embodiment of the invention disposed upon the user's mattress in a flat state, in which the left side bladders are uninflated and the right side bladders are also un-inflated, allowing a user to lie flat upon the invention.

FIG. 1b depicts a view an embodiment of the inflatable bladders of the invention disposed upon the user's mattress in a first state, in which the first set, or left side bladders, have been inflated and the second set, or right side bladders are un-inflated, rotating the user's body been onto its right side in a first position.

FIG. 1c depicts a view of an embodiment the inflatable bladders of the invention disposed upon the user's mattress in a second state, in which the second set, or right side bladders have been inflated and the first set, or left side bladders are un-inflated, rotating the user's body been onto its left side in a second position.

FIG. 2a depicts a top view of a flat sheet of material that may be used to create a set of bladders of the invention.

FIG. 2b depicts the folding of the flat sheet of material which results in the creation of an embodiment of a set of bladders of the invention.

FIG. 2c depicts the completion of the fabrication of an embodiment of bladders of the invention, showing areas in which areas of the folded flat sheets of material are joined together by creating seams to create bladders with fill holes for inflating and deflating.

FIG. 2d depicts a cross sectional view of an embodiment of the bladders of the invention.

FIG. 3 depicts the attachment of a right angle connector and tubing to a fill hole of the bladder of the invention, allowing inflation and deflation of the bladder.

FIG. 4 depicts a schematic diagram of an embodiment of the invention which shows the pneumatic communication between bladders of the invention and the at least one air pump and valves of the invention.

FIG. 5 depicts an exploded perspective bottom view of an embodiment of the invention, showing the orientation and disposition of an upper set of bladders onto a lower set of bladders, and further depicts straps which may be used to secure the lower bladders of the invention onto a user's mattress.

FIG. 6 depicts an assembled perspective bottom view of an embodiment of the invention, showing the orientation and disposition of an upper set of bladders onto a lower set of bladders, and further depicts straps which may be used to secure the lower bladders of the invention onto a user's mattress.

FIG. 7. depicts a perspective bottom view of an embodiment of the assembled invention and further depicts an embodiment of the at least one air pump, valves, and controller of the invention in fluid communication with the inflatable bladders of the invention via fluid tubing so that the bladders of the invention may be inflated and deflated by the at least one air pump and valve of the invention in which the fluid tubing is shown in exploded view.

FIG. 8 depicts a perspective bottom view of an embodiment of the assembled invention and further depicts an embodiment of the at least one air pump, valves, and controller of the invention in fluid communication with the inflatable bladders of the invention via tubing so that the bladders of the invention may be inflated and deflated by the at least one air pump and valves of the invention in which the fluid tubing is shown in assembled view.

FIG. 9 depicts a top view of an embodiment of an air pump and valve assembly of the invention which comprises plenums, with the housing top cover removed.

FIG. 10 depicts a cross sectional side view of an embodiment of an air pump and valve assembly of the invention which comprises plenums.

FIG. 11 depicts a perspective exploded view of one exemplary embodiment of a plenum version of the pump and valve assembly of the invention.

FIG. 12 depicts a further perspective exploded view of one exemplary embodiment of a plenum version of the pump and valve assembly of the invention.

FIG. 13 depicts an exemplary fluid block diagram of an embodiment of the invention in which a plenum-style air pump and valve assembly comprise the invention, depicting the operation of the valves and air flow when filling a first set of bladders with a fluid such as air, where the fluid such as outside air is drawn from an environment outside the pump and valve assembly.

FIG. 14 depicts an exemplary fluid block diagram of an embodiment of the invention in which a plenum-style air pump and valve assembly comprise the invention, depicting the operation of the valves and air flow when filling a second set of bladders with a fluid such as air, where the fluid is drawn from an outside fluid source such as outside air.

FIG. 15 depicts an exemplary fluid block diagram of an embodiment of the invention in which a plenum-style air pump and valve assembly comprise the invention, depicting the operation of the valves and air flow when filling a first set of bladders with a fluid such as air, where the fluid is drawn from a second set of bladders.

FIG. 16 depicts an exemplary fluid block diagram of an embodiment of the invention in which a plenum-style air pump and valve assembly comprise the invention, depicting the operation of the valves and air flow when filling a second set of bladders with a fluid such as air, where the fluid is drawn from a first set of bladders.

FIG. 17 depicts an exemplary fluid block diagram of an embodiment of the invention in which a plenum-style air pump and valve assembly comprise the invention, depicting the operation of the valves and air flow when emptying, or deflating, both a first set and second set of bladders.

FIG. 18 depicts an exemplary electrical block diagram of an embodiment of the invention.

### DETAILED DESCRIPTION OF THE INVENTION

The following documentation provides a detailed description of exemplary embodiments of the invention. Although a detailed description as provided herein contains many specifics for the purposes of illustration, anyone of ordinary skill in the art will appreciate that many variations, equivalents and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

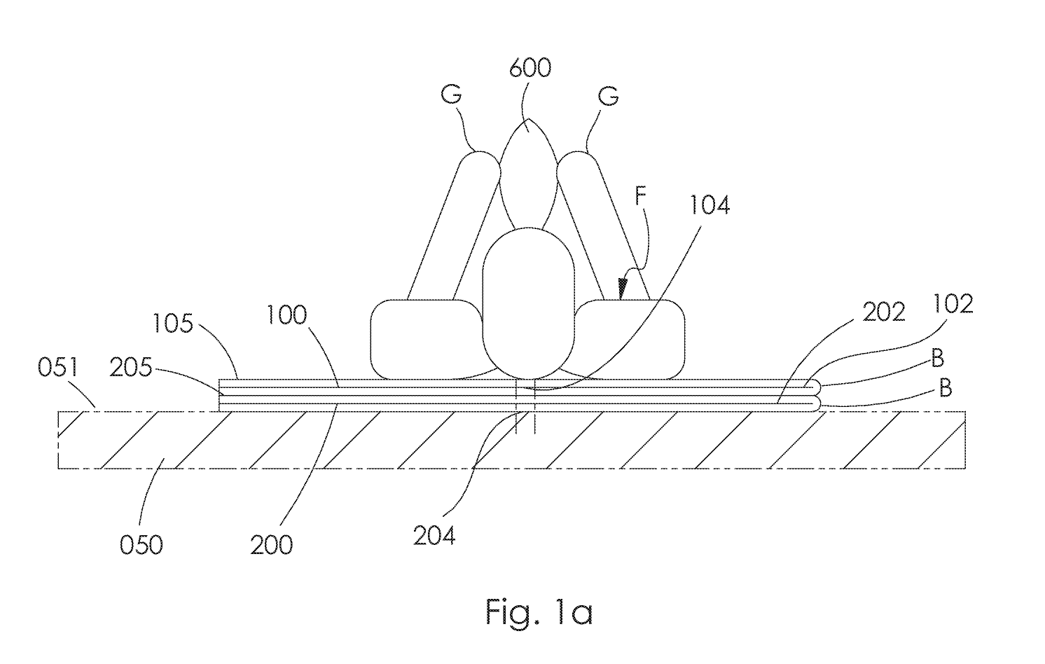

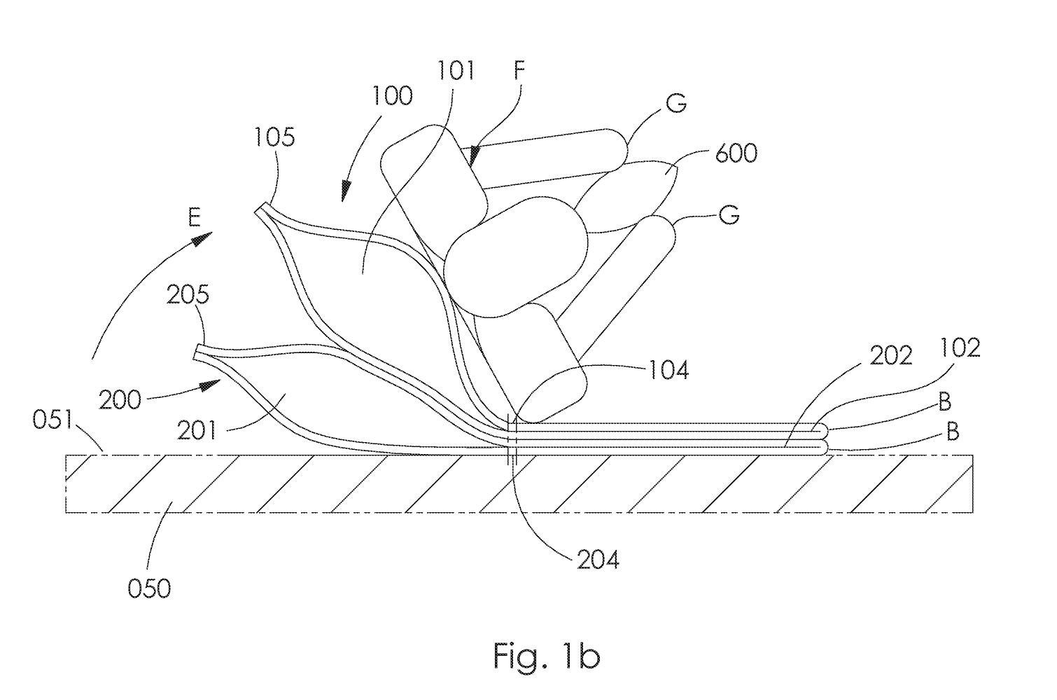

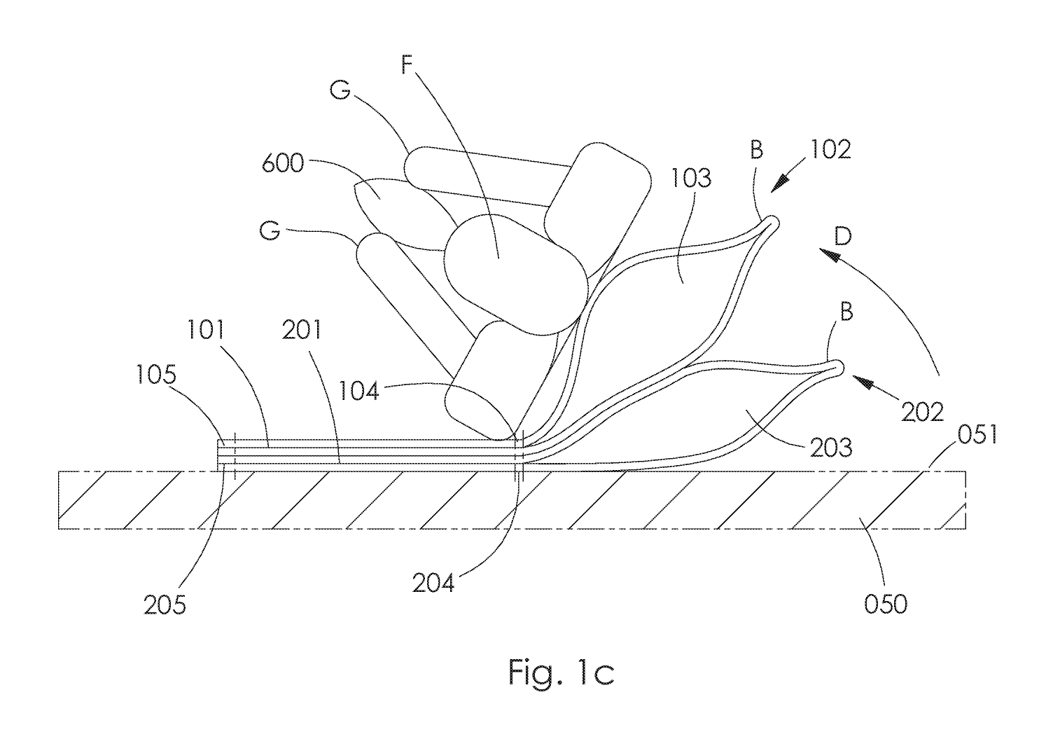

Referring now to FIGS. 1a-1c, cross-sectional views of the bladders of the invention disposed upon an upper surface 051 of a user's mattress 050 are depicted in which the invention is depicted a flat state in FIG. 1a, a first state in FIG. 1b and a second state in FIG. 1c. In operation the invention may take any one of these several states. In the flat state, all bladders of the invention may be un-inflated as depicted in FIG. 1a. In the first state, a first set of bladders comprising upper left side bladder 100 and lower left side bladder 200 of the invention may be inflated and upper right side bladder 102 and lower right side bladder 202 may be un-inflated, as shown in FIG. 1b. Alternatively, in the second state, a second set of bladders comprising upper right side bladder 102 and lower right side letter 202 may be inflated and upper left side ladder 100 and lower left side bladder 200 may be un-inflated as depicted in FIG. 1c. In a typical use of the invention, the flat state of the invention may be the initial state in which the person utilizes the invention.

Still referring to FIGS. 1a-1c, the invention is adapted to be used on an upper surface 051 of a user's traditional mattress 050 so that mattress 050 replacement is not required when using the apparatus and method of the invention, allowing the user to continue use of the mattress of his or her choice while having the ability to be turned in bed by the operation of the invention. Mattress 050 may be any type of mattress or sleeping surface known in the art, or alternatively may be any substantially flat surface. The invention may comprise an upper set of bladders and a lower set of bladders which may be, but are not necessarily, fabricated from the method set forth below. Each of the upper set of bladders and lower set of bladders may further comprise a right side bladder and a left side bladder with a sealed seam between them preventing a fluid from directly transitioning between the left side bladder to the right side bladder. Thus, for example, the upper left side bladder 100 and lower left side bladder 200 of the invention may be independently filed with a fluid, or inflated, while leaving upper right side bladder 102 and lower right side bladder 202 empty or un-inflated, as depicted in the second state of the invention shown in FIG. 1b. Alternatively, upper right side bladder 102 and lower right side bladder 202 may be independently filled with fluid, or inflated, while leaving upper left side bladder 100 and lower left side bladder 200 empty or un-inflated as depicted in the third state of the invention shown in FIG. 1c.

Referring now to FIG. 1a, a view of the invention in a flat state is depicted. In this flat state, all bladders of the invention are substantially empty of fluid so that they lie reasonably flat, or deflated, allowing a user F to lie on the invention and experience the feel of mattress 050. First upper bladder 100 and second upper bladder 200 are indicated for reference, as are upper bladder set peripheral seal 105 and lower bladder set peripheral seal 205. Upper bladder set dividing seal 104 and lower bladder set dividing seal 204, further described below, and upper bladder set and lower bladder set fold lines B are also depicted for reference. The user may lie upon the invention in the flat state until such time as it is desired to move into either the first or second state of the invention, as depicted in FIGS. 1b and 1c, respectively, and as further described below. In the flat state, the user may experience the softness and feel of the mattress 050 because the softness and feel of mattress 050 would be transmitted through the layers of upper left side bladder 100 and lower left side letter 200 to be perceived by the user, as these bladders are not inflated in the flat state. Optional bladder 600 may be placed between a user's legs G to further prevent bed sores and to aid in turning.

Referring now to FIG. 1b a view of the invention in a first state is depicted. When it is desired to transition from the flat state, in which all bladders of the invention are un-inflated, to the first state as show in FIG. 1b, the bladders of the left side of the invention may be inflated by filling upper left side bladder interior volume 101 and lower left side bladder interior volume 201 with a fluid, such as a compressible fluid which may be, for example, air from at least one fluid pump that is in fluid communication with the bladders of the invention. As an example, a user may initially lie upon the invention as it is disposed upon upper surface 051 of mattress 050. When it is desired to turn the body onto its right side, the at least one pump and valves of the invention may be utilized to pump fluid into interior volume 101 of upper left side bladder 100 and into interior volume 201 of lower left side bladder 200, transitioning the invention from the flat state to the first state and causing the user's body F to be lifted and rotated onto the user's right side in the direction of arrow E as the upper left side bladder 100 and lower left side bladder 200 are inflated. Eventually, as the upper left side bladder 100 and lower left side bladder 200 continue to be inflated, the user's body F is rolled in the direction of rotation shown by arrow E onto its right side into a first position as depicted. Just prior to, or contemporaneously with, the body of the user F being rolled onto its right side, inflation of upper left side bladder 100 and lower left side bladder 200 may cease, leaving the user's body F disposed upon its right side as depicted in FIG. 1b. Upper bladder set peripheral seal 105 and lower bladder set peripheral seal 205, upper bladder set dividing seal 104 and lower bladder set dividing seal 204, and upper bladder set and lower bladder set fold lines B, all of which are described in further detail below, are depicted for reference. Upper right side bladder 102 and lower right side bladder 202 remain uninflated in the first state of the invention. From the first state of the invention in which the user's body is disposed on its right side, a transition to either the flat state or second state of the invention may be realized. Optional bladder 600 may be placed between a user's legs G to further prevent bed sores and to aid in turning.

When it is desired to transition from the first state to the flat state, the at least one air pump and valves of the invention are utilized to remove air from upper left side bladder interior volume 101 of upper left side bladder 100 and air from upper left side bladder interior volume 201 of lower left side bladder 200, causing these bladders to deflate. When fully deflated, the invention will be in the flat state as shown in FIG. 1a, wherein the user may lie flat or in any other position upon the invention.

Referring now to FIGS. 1b and 1c, when it is desired to transition from the first state to the second state, the at least one air pump and valves of the invention may be utilized to remove fluid, which may be air, from upper left side bladder interior volume 101 of upper left side bladder 100 and from upper left side bladder interior volume 201 of lower left side bladder 200 causing these bladders to deflate and become relatively flat; and also pumping fluid, which may be air, into upper right side bladder interior volume 103 of second upper bladder 102 and into lower right side bladder interior volume 203 of second lower bladder 202. If the fluid has not yet been removed from upper left side bladder 100 and lower left side bladder 200, the at least one air pump and valve of the invention may be utilized to contemporaneously remove the fluid from upper left side bladder 100 and from lower left side bladder 200 by pumping fluid from interior volume 101 of upper left side bladder 100 and interior volume 201 of lower left side bladder 200. The inflation of upper right side bladder 102 and lower right side bladder 202 and deflation of upper left side bladder 100 and lower left side letter 200 cause the invention to transition into the second state, and will cause the body of the user F to be rolled from its right side onto its left side as depicted by arrow D. Just prior to, or contemporaneously with, the body of the user F being rolled onto its left side as shown in FIG. 1c, inflation of upper right side bladder 102 and lower right side bladder 202 may cease. From the second state of the invention, a transition to the flat or first state may be realized.

Referring now to FIG. 1c a view of the invention in a second state is depicted. When it is desired to transition from the flat state, in which all bladders of the invention are un-inflated, to the second state as show in FIG. 1c, the second set of bladders of the right side of the invention may be inflated by filling upper right side bladder interior volume 103 and lower right side bladder interior volume 203 with a fluid, such as a compressible fluid which may be, for example, air from at least one fluid pump that is in fluid communication with the bladders of the invention. As an example, a user may initially lie in a flat position upon the invention as it is disposed upon upper surface 051 of mattress 050. When it is desired to turn the body onto its left side, the at least one pump and valves of the invention may be utilized to pump fluid into interior volume 103 of upper right side bladder 102 and into interior volume 203 of lower right side ladder 202, transitioning the invention from the flat state to the second state and causing the user's body F to be rotated onto the user's left side in the direction of arrow D as the upper right side bladder 102 and lower right side bladder 202 are inflated. Eventually, as the upper right side bladder 102 and lower right side bladder 202 continue to be inflated, the user's body F is rolled over in the direction of rotation shown by arrow D onto its left side in a second state as depicted. Just prior to, or contemporaneously with, the body of the user F being rolled onto its left side, inflation of upper right side bladder 102 and lower right side bladder 202 may cease, leaving the user's body F disposed upon its left side as depicted in FIG. 1c. Upper bladder set peripheral seal 105 and lower bladder set peripheral seal 205, upper bladder set dividing seal 104 and lower bladder set dividing seal 204, and upper bladder set and lower bladder set fold lines B, all of which are described in further detail below, are depicted for reference. Upper left side bladder 100 and lower left side bladder 200 remain uninflated in the second state of the invention. From the second state of the invention in which the user's body is disposed on its left side, a transition to either the flat state or second state of the invention may be realized.

Still referring to FIG. 1c, when it is desired to transition from the second state to the flat state, the at least one air pump and valves of the invention are utilized to remove air from upper right side bladder 102 and lower right side bladder 202 causing these bladders to deflate. When fully deflated, the invention will be in the flat state as shown in FIG. 1a, wherein the user may lie flat upon the invention.

Referring now to FIGS. 1b and 1c, when it is desired to transition from the second state to the first state, the at least one air pump and valves of the invention may be utilized to remove fluid, which may be air, from upper right side bladder interior volume 103 of upper right side bladder 102 and from lower right side bladder interior volume 203 of lower right side bladder 202 causing these bladders to deflate and become relatively flat; and also pumping fluid, which may be air, into upper left side bladder interior volume 101 of upper left side bladder 100 and into lower left side bladder interior volume 201 of lower left side bladder 200. If the fluid has not yet been removed from upper right side bladder 102 and lower right side bladder 202, the at least one air pump and valve of the invention may be utilized to contemporaneously remove the fluid from upper right side bladder 102 and from lower right side bladder 202 by pumping fluid from interior volume 103 of upper right side bladder 102 and interior volume 203 of lower right side bladder 202. The inflation of upper left side bladder 100 and lower left side bladder 200 and deflation of upper right side bladder 102 and lower right side letter 202 cause the invention to transition into the first state, and will cause the body of the user F to be rolled from its left side onto its right side as depicted by arrow E. Just prior to, or contemporaneously with, the body of the user F being rolled onto its right side as shown in FIG. 1b, inflation of upper left side bladder 100 and lower left side bladder 200 may cease.

In this manner, the body of a user may be turned from one side to the other, and vice versa, as desired, using the inflation and deflation functions the invention to cause the invention to transition between the flat, first or second states as desired.

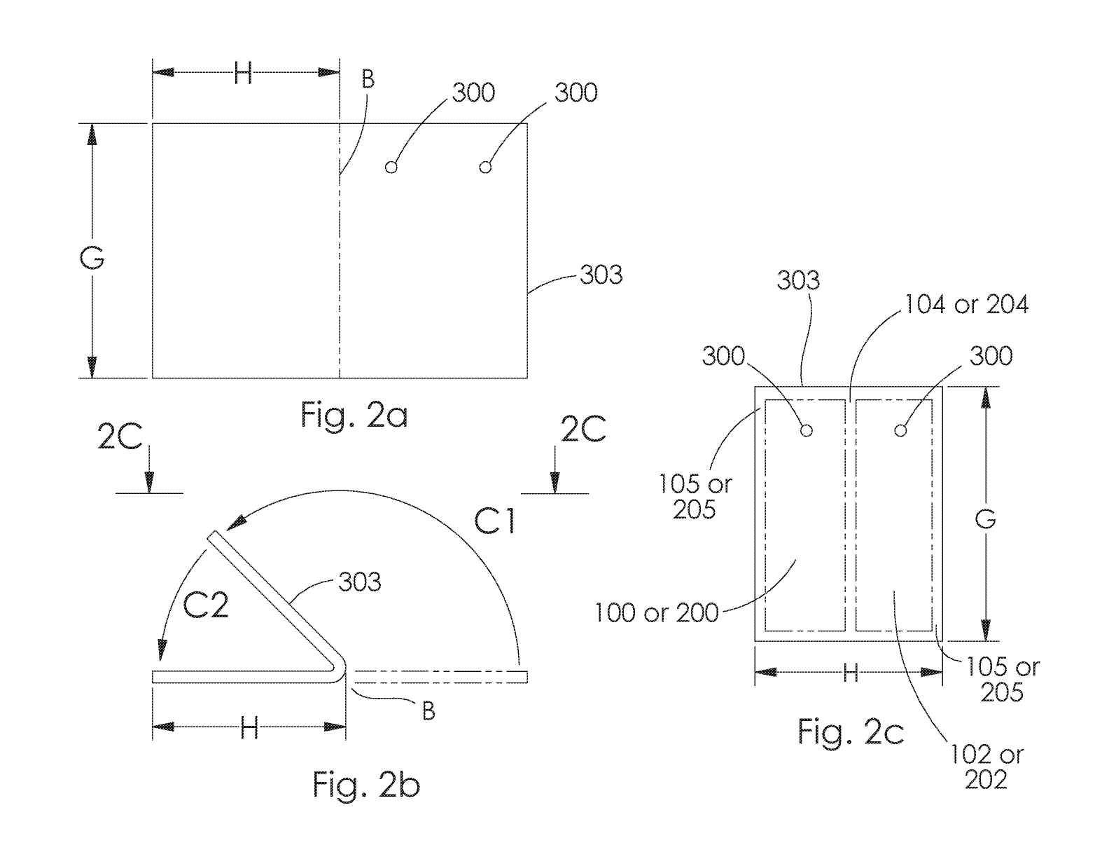

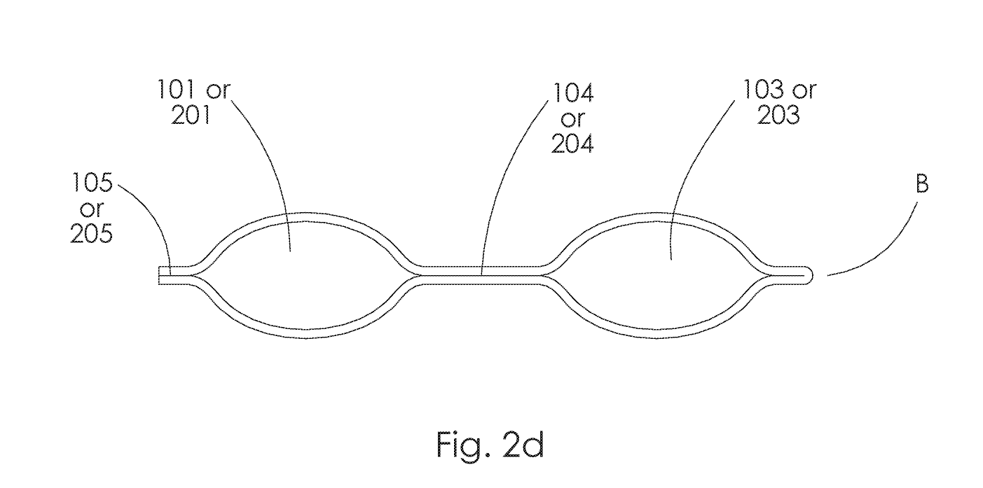

Referring now to FIGS. 2a, 2b and 2c, an exemplary method for fabrication of upper and lower bladder sets, which may comprise the bladders of the invention, is depicted. Each bladder of the invention may comprise an inflatable container having an interior volume and being capable of receiving and being inflated by a fluid such as air pumped into interior volume thereof by for example an air pump, and also capable of releasing air from its interior volume so that it may be deflated as desired by a user. An exemplary method for fabrication of the upper and lower bladder sets of the invention is depicted in FIGS. 2a, 2b and 2c. However, it is to be noted that the invention may comprise bladders and/or upper and/or lower bladder sets that are fabricated using any known technique for fabricating inflatable bladders and any known material for fabrication of inflatable bladders. The method for fabrication of the upper and lower bladder sets described herein and depicted in the figures is exemplary.

Still referring to FIGS. 2a, 2b, 2c and 2d, in an exemplary method for fabrication of the upper and lower bladder sets of the invention, a flat material sheet 303 may be folded upon itself along fold line B through angle C1 and continuing through angle C2 so as to form a folded shape of length G and width H. The folded shape as depicted in FIG. 2c may then be sealed by any method known in the art along its periphery at area 105 in the case of the upper bladder set and at area 205 in the case of the lower ladder set, and may be sealed along an interior seal area 104 in the case of the upper bladder set and 204 in the case of the lower bladder set to create individually sealed left upper bladder 100 and individually sealed right upper bladder 102 in the case of the upper bladder set and individually sealed left lower bladder 200 and individually sealed right lower bladder 202 in the case of the lower bladder set. The method for sealing areas 105, 205, 104 and 204 may be any method known in the art for sealing bladder materials together such as for instance chemical bonding, laser welding, friction welding, linear vibration welding, thermal welding, solvent welding, ultrasonic welding, radio-frequency welding, and equivalent methods known in the art. At least one inflation hole 300, which is adapted to receive a fluid fitting for inflating the bladder, may be disposed in each of the bladders formed by the folding and sealing of flat sheet 303 as described herein. The material utilized for flat material sheet 303 may be any material known in the art for creating bladders that are capable of holding fluids, which may be a compressible gas such as air or a liquid such as water, and holding pressure without leaking. Such materials may be, for example, PVC (polyvinylchloride) coated nylon, polyurethane coated nylon, any PVC or polyurethane coated fibrous material, rubber, or the like. In the case of coated nylon materials, the nylon (uncoated) side of the material may face outward from the bladder so that as to provide a breathable outer surface that is not objectionable to the touch and does not trap, or retain, body heat if in direct contact with the user's skin. Heat sealable PVC coated 200 Denier Oxford nylon is one of many materials which may comprise flat material sheet 303.

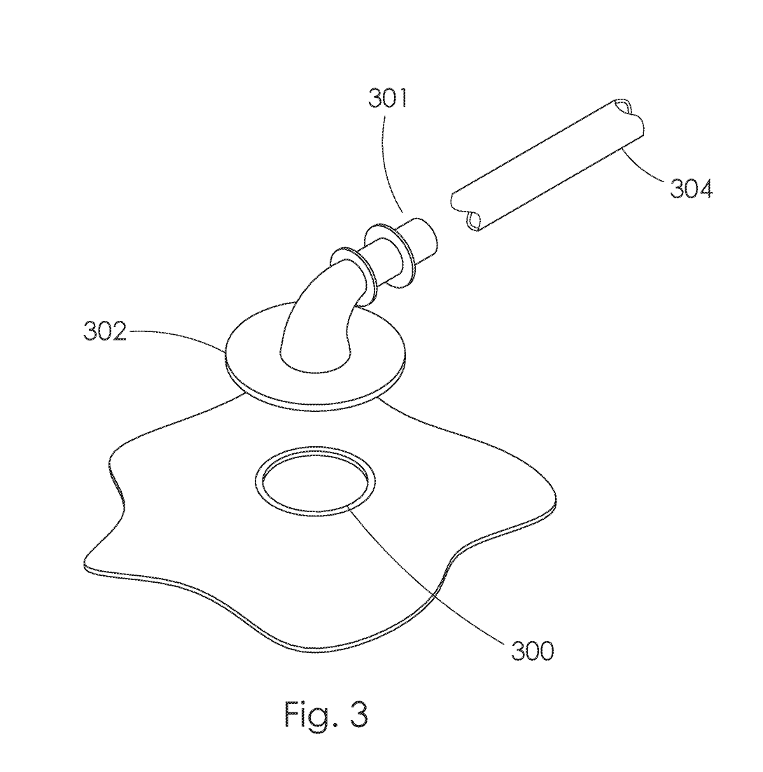

Referring now to FIG. 3, each bladder inflation hole may be adapted to receive a fluid fitting for inflation of the bladder, such as for example right angle fluid connector 302 which may further comprise a barbed interface 301 adapted to receive fluid tubing 304, which is preferably flexible tubing, such that a fluid such as air may pass into or out of each of the bladders of the invention through fill hole 300, through right angle fluid connector 302 and through pneumatic tubing 304. In this manner, the air valve and pump of the system may be in in fluid communication with each of the bladders of the system so that each of the bladders may be independently inflated and/or deflated as desired by the user and as described by the description of the operation of the invention provided herein. Is not necessary that a right angle adapter 302 to be used to connect tubing 304 to each bladder; the invention may comprise any fitting that creates a fluid communication between tubing 304 and the bladders of the invention. It is to be understood that the fluid components depicted in FIG. 3 are exemplary and that any combination of pneumatic or hydraulic components known in the art for providing fluid communication between the pump, valve and bladders of the invention may be utilized and are within the scope of the claimed invention.

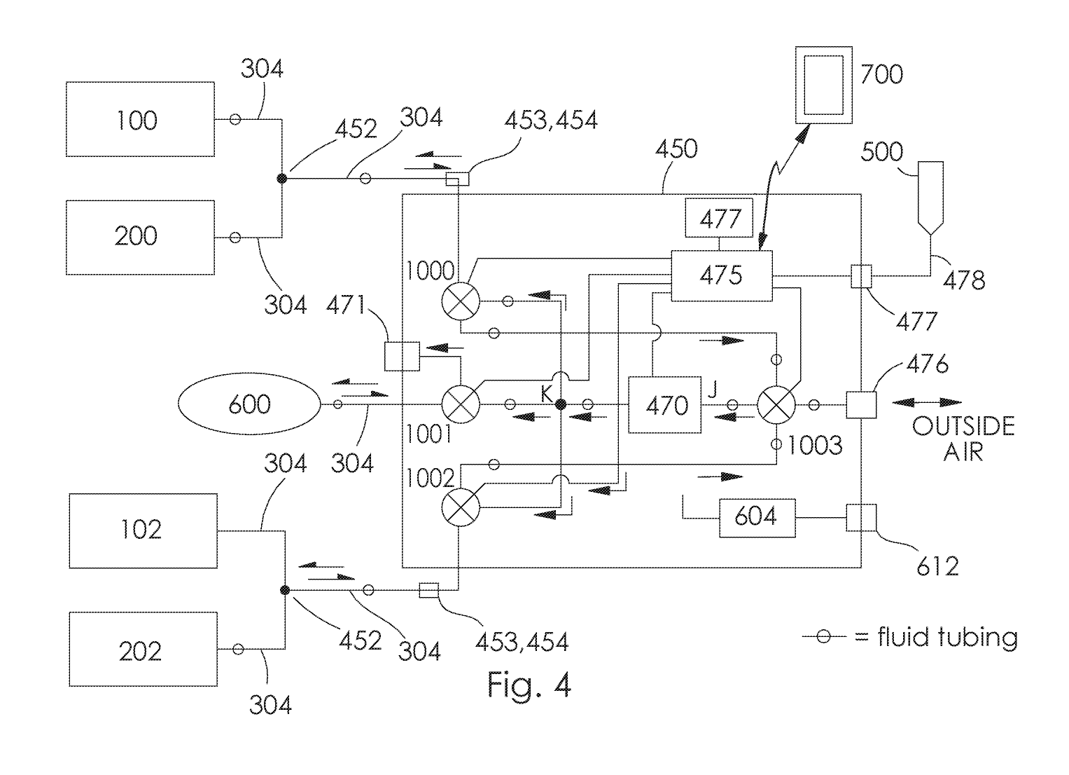

Referring now to FIG. 4, a schematic diagram of one embodiment of the pneumatic or hydraulic system of the invention is depicted. A first set of bladders comprising upper left bladder 100 and lower left bladder 200 may be in fluid communication with each other through fluid tubing 304 and fluid T adapter 452, and further may be in fluid communication with at least one fluid pump 470 and valves as depicted in FIG. 4, such that upper left bladder 100 and lower left bladder 200 may be simultaneously inflated or deflated by operation of at least one air pump 470 and valves. Likewise, upper left bladder 102 and lower right bladder 202 are in fluid communication with one another through fluid tubing 304 pneumatic T adapter 452 as depicted in the diagram and are further in fluid communication with at least one air pump 470 and valves, such that upper left bladder 102 and lower right 202 may be simultaneously inflated or deflated by operation of at least one air pump 470.

Still referring to FIG. 4, the operation of an embodiment of air pump and valve assembly 450 is now described in further detail. While a specific embodiment of the of air pump and valve assembly 450 is shown and described in FIG. 4, any combination and configuration of air pump or pumps, valves, controllers or tubing may comprise air pump and valve assembly 450. Air pump and valve assembly 450 may comprise a processor 475 capable of executing non-transitory computer readable instructions which may be in electrical communication with a non-transitory computer readable media 477 for storing non-transitory computer readable instructions which media may reside on-board processor 475 or alternatively may be a separate electronic memory device, and which may also be in electrical communication with processor 475. Processor 475 may also be in electrical communication with a first valve 1000; a second valve 1001; a third valve 1002; a fourth valve 1003; a controller 500 for receiving user commands and for providing user commands to processor 475, where controller 500 may comprise a human user interface such as, by way of example, a keypad, touchscreen, keys, audio command capability, or any other user input devices known in the computer and electrical arts; and fluid pump 470. Fluid pump 470 may be a high volume/low pressure air pump or any other fluid pump. Processor 475, non-transitory computer readable memory 477, first valve 1000, second valve 1001, third valve 1002, fourth valve 1003, controller 500 and fluid pump 470 may all also be in electrical communication with a power supply 604 which may comprise batteries, power conditioning electrical circuitry, AC to DC power conversion, or any other source of power known in the electrical arts. The power supply and batteries may be configured so as to provide battery backup power during a loss of external electrical power, such as, for example, when house current fails. Controller 500 may also be in wireless communication with processor 475 by any wireless means known in the art which may be optical, radio frequency such as the wireless standard known as Bluetooth®, WiFi®, IEEE 802.XX, Near Field Communications (NFC), infrared or any other wireless communication means of any frequency and protocol, whether standardized or not standardized. Furthermore, processor 475 may be in wireless communication with a remote electronic device 700 which may, for example but not necessarily, be a computer or handheld electronic device such as an electronic tablet, smartphone, personal computer or any other handheld device that comprises a user input such as a keyboard and wireless communication circuitry for wireless communication with processor 475. Such wireless communication may be any form of wireless communication known in the art and may be optical, radio frequency such as the wireless standard known as Bluetooth®, WiFi®, IEEE 802.XX, Near Field Communications (NFC), infrared or any other wireless communication means of any frequency and communication protocol, whether standardized or not standardized. Air pump and valve assembly 450 or controller 500, or both of them, may further comprise wireless transceivers in electrical communication with their internal processors which may be optical or RF transceivers, or any other wireless transceiver known in the electrical arts for wireless data communication, in wireless communication with each other and also, in alternate embodiments, with a remote electronic device which may be a computer or handheld electronic device such as an electronic tablet, smartphone or any other handheld device that comprises a user input and wireless communication circuitry for wireless communication. Controller 500 or 700 may also be programmable through a smart phone or other electronic device executing computer readable instructions, which instructions may allow user input to set the timing interval between rotations of the user's body, the pressure limits for the bladders, and any other operational feature controlled by processor 475. The smart phone or electronic device application may comprise non-transitory computer readable instructions stored in non-transitory computer readable media, which computer readable instructions may be executed on the processor or microcontroller or other device capable of executing computer readable instructions such as a firmware controller or microprocessor on the user's smartphone or electronic device which is capable of executing computer readable instructions and which is in electrical communication with said non-transitory computer readable memory containing the computer readable instructions. The user's smartphone or other electronic device may be in wireless communication with processor 475 or controller 500, or both, by any wireless communication system known in the art such as, for example, WiFi (IEEE 802.11), Bluetooth®, Near Field Communications (NFC), infrared, or any other known means for wireless communication including RF and infrared communications.

Still referring to FIG. 4, processor 475 may be directly controlled or programmed by controller 500 or by a remote electronic device 700 such as a computer, smart phone or tablet to perform the functions described herein automatically, for example on a timed basis, or to perform the following functions on a manual, or “as-commanded”, basis upon receiving commands from controller 500, or any combination of automatic and manual commanded operation.

Still referring to FIG. 4, any of the sets of bladders may be individually inflated or deflated at set times or intervals. Bladders 100 and 200 may be commanded to inflate simultaneously, while bladders 102 and 202 are left uninflated, resulting in a first state of the invention as depicted in FIG. 1b. Likewise, bladders 102 and 202 may be commanded to inflate simultaneously, while bladders 100 and 200 are left uninflated, resulting in a second state of the invention as depicted in FIG. 1c.

Still referring to FIG. 4, the inflation of bladders 100 and 200 may be accomplished by filling them with fluid, which may be air, which has been evacuated from bladders 102 and 202, and likewise the inflation of bladders 102 and 202 may be accomplished by filling them with fluid that has been evacuated from bladders 100 and 200. This may be accomplished by the operation of valves 1000, 1002 and 1003. In the case in which it is desired to fill bladders 100 and 200 with fluid that has been evacuated from bladders 102 and 202, valve 1000 is commanded to pass fluid from pump 470 to bladders 100 and 200. Valve 1003 is commanded to direct fluid from valve 1002 to the inlet J of pump 470, and to shut off fluid communication with outside air through optional filter 476. Valve 1002 is commanded to allow fluid from bladders 102 and 202 to be communicated to valve 1003, where it can pass to the inlet of pump 470 and be pumped into bladders 100 and 200. In this manner, bladders 100 and 200 may be filled with fluid while bladders 100 and 200 are being emptied of fluid, resulting in turning of the user as depicted in FIG. 1b. In the case in which it is desired to fill bladders 102 and 202 with fluid that has been evacuated from bladders 100 and 200, valve 1002 is commanded to pass fluid from pump 470 to bladders 102 and 202. Valve 1003 is commanded to direct fluid from valve 1000 to the inlet J of pump 470, and to shut off fluid communication with outside air through optional filter 476. Valve 1000 is commanded to allow fluid from bladders 100 and 200 to be communicated to valve 1003, where it can pass to the inlet of pump 470 and be pumped into bladders 102 and 202 through valve 1002. In this manner, bladders 102 and 202 may be filled with fluid with fluid from bladders 100 and 200, resulting in turning of the user as depicted in FIG. 1c.

Still referring to FIG. 4, the inflation of bladders 100 and 200 may be accomplished by filling them with fluid from outside pump and valve assembly 450, which may be for example outside air, by bringing fluid such as air through optional filter 476. This may be accomplished by the operation of valves 1000 and 1003. In the case in which it is desired to fill bladders 100 and 200 with fluid from outside pump and valve assembly 450, valve 1000 is commanded to pass fluid from pump 470 to bladders 100 and 200. Valve 1003 is commanded to direct fluid from outside pump and valve assembly 450, for example through optional filter 476 to the inlet J of pump 470 where it is pumped through valve 1000 and into bladders 100 and 200, and to shut off fluid communication with valve 1002. In this manner, bladders 100 and 200 may be filled with fluid from outside pump and valve assembly 450, resulting in turning of the user as depicted in FIG. 1b. Still referring to FIG. 4, the inflation of bladders 102 and 202 may be accomplished by filling them with fluid from outside pump and valve assembly 450 by bringing fluid through optional filter 476. This may be accomplished by the operation of valves 1000 and 1002. In the case in which it is desired to fill bladders 102 and 202 with fluid from outside pump and valve assembly 450, valve 1002 is commanded to pass fluid from pump 470 to bladders 102 and 202. Valve 1003 is commanded to direct fluid from outside pump and valve assembly 450, for example through optional filter 476, to the inlet of pump 470 where it is pumped through valve 1002 and into bladders 102 and 202, and to shut off fluid communication with valve 1000. In this manner, bladders 102 and 202 may be filled with fluid from outside pump and valve assembly 450, resulting in turning of the user as depicted in FIG. 1c.

Still referring to FIG. 4, controller 475 may execute computer readable instructions that command timed operation of the fluid pump and valve assembly such that the apparatus may be programmed to rotate the user between the left side, back and right positions on a timed basis or at predetermined times without the user manually interfacing with controller 500 or controller 700. This automatic, programmed, variably-timed operation allows a user to sleep without worry of developing pressure sores. Pressure sensors 454 may be in electrical or wireless communication with fluid pump and valve assembly 450 and may operate to shut off fluid pump and valve assembly 450 once a pre-determined desired pressure is reached in the bladders being inflated. This feature of the invention prevents over-inflation of any of the bladders. Pressure relief valves 453 may be disposed in any of the fluid tubing lines that are in fluid communication with each of the bladders of the invention. Pressure relief valves 453 may be any type of relief valve known in the art, but may be, for example, spring loaded plunger valves that operate to open when the pressure in the tubing reaches a pre-determined level. In this manner, the bladders of the invention are protected from a malfunctioning controller 500 or fluid pump and valve assembly 450 if, for instance, the fluid pump fails to shut off when the desired bladder pressure is reached. The pressure relief valves may, for example, be preset to open at a pressure of 1.0 p.s.i. relative to the atmospheric pressure outside the bladders, although any preset value may be used.

Still referring to FIG. 4, valve 1000 may be commanded to allow fluid flow from the output K of pump 470 to inflatable bladder 600, which may be used to place between a user's legs in order to keep the skin of one leg from remaining in contact with the skin of the other leg of the user. Fluid, which may be air, may be evacuated from inflatable bladder 600 when valve 1000 is commanded to allow fluid flow from inflatable bladder 600 to fluid port 471, allowing fluid from inflatable bladder 600 to leave inflatable bladder 600 and to be communicated to the environment external to pump and valve assembly 450.

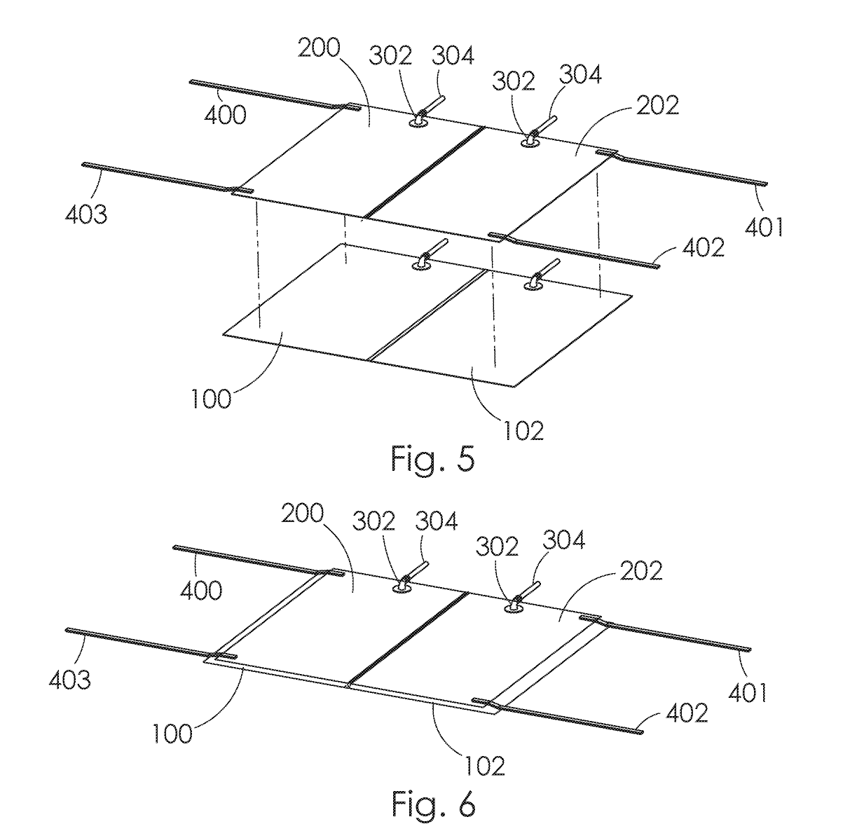

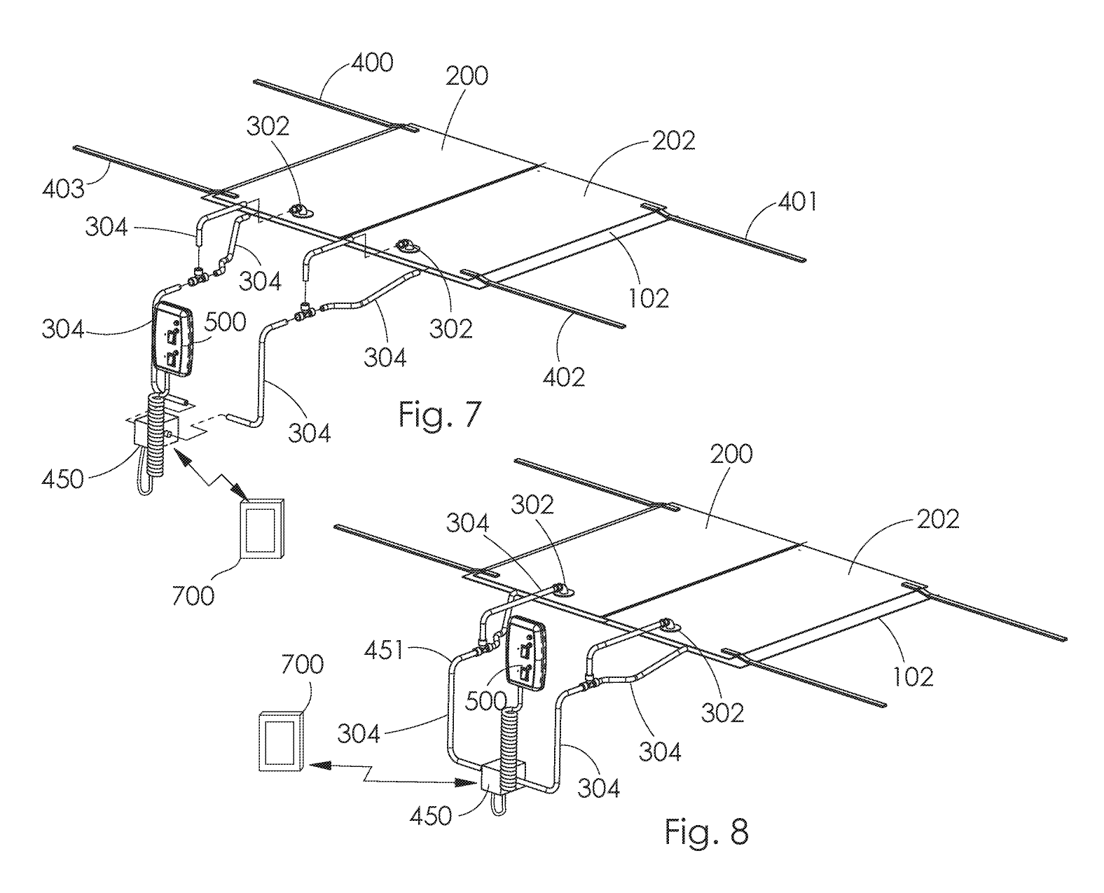

Referring now to FIGS. 5, 6, 7 and 8, perspective views of an exemplary embodiment of the invention are depicted. Straps 400, 401, 402 and 403 for securing the invention to a mattress or other structure may comprise any material known for fabrication of straps including webbing, textile, plastic, any woven material or any material known in the art for fabricating straps. Straps 401 and 402 may be attached to bladder 202 as depicted by any means known in the art such as, for example, stitching, pressure sensitive adhesive or chemical bonding. Likewise, straps 400 and 403 may be attached to bladder 200 as depicted by any means known in the art such as, for example, stitching or chemical bonding. Pneumatic or hydraulic tubing 304 may be in pneumatic or hydraulic communication with fluid connectors 302 located on bladders 100, 102, 200 and 202 and also may be in pneumatic or hydraulic communication with fluid pump and valve assembly 450 which may be in electrical communication with controller 500.

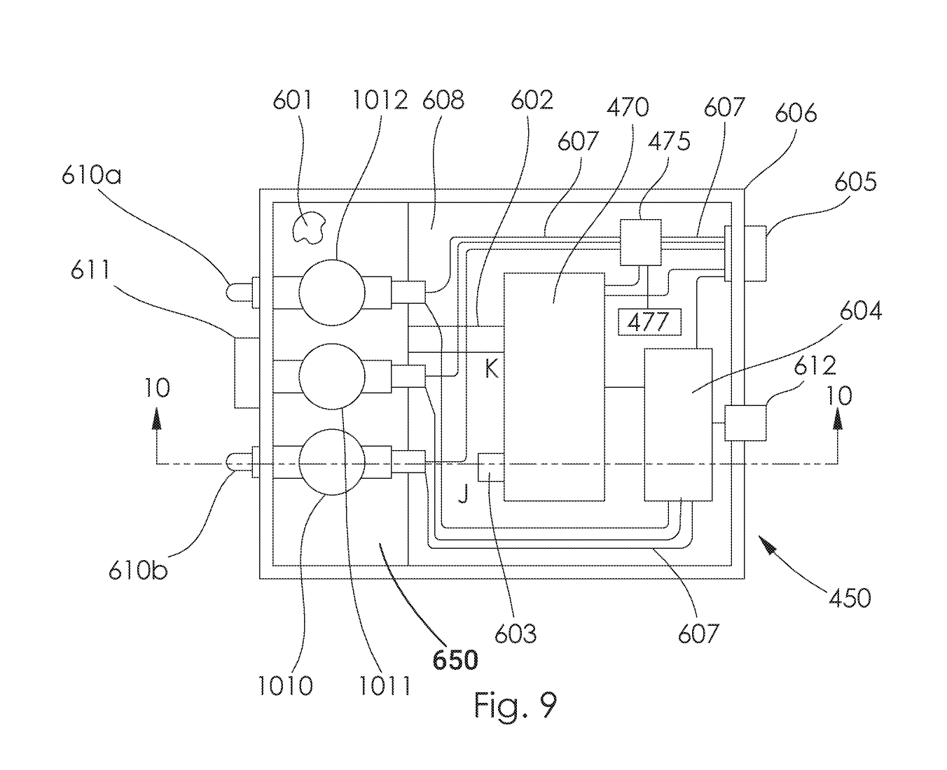

An embodiment of the invention in which the air pump and valve assembly 450 comprises a first and second plenum is depicted in FIGS. 9-17. In this embodiment, some of the pneumatic or hydraulic tubing is replaced by the first and second plenums, and only three fluid valves are required for operation of the invention. In this embodiment, first fluid valve 1010, second fluid valve 1011 and a third fluid valve 1012 may be diverter valves, meaning that they have a first, second, and third fluid port. The diverter valves are configured such they may be commanded into one of three states: a first state in which the first port is in fluid communication with the third port allowing fluid to pass between the first and third ports, and there is no fluid communication between the second and third ports; a second state in which the second port is in fluid communication with the third port allowing fluid to pass between the second and third ports, and there is no fluid communication between the first and third ports; and a third state, called the OFF state, in which neither the first or second ports are in fluid communication with the third port. The command causing a valve to enter a specific state may be in the form of an electrical signal from processor 475. Processor 475 may receive user input for a desired state from a wired controller 500 (not shown in FIGS. 9-15) or wireless controller 700, which may be a smart phone, handheld electronic device, electronic tablet, personal computer or other similar device as hereinbefore described.

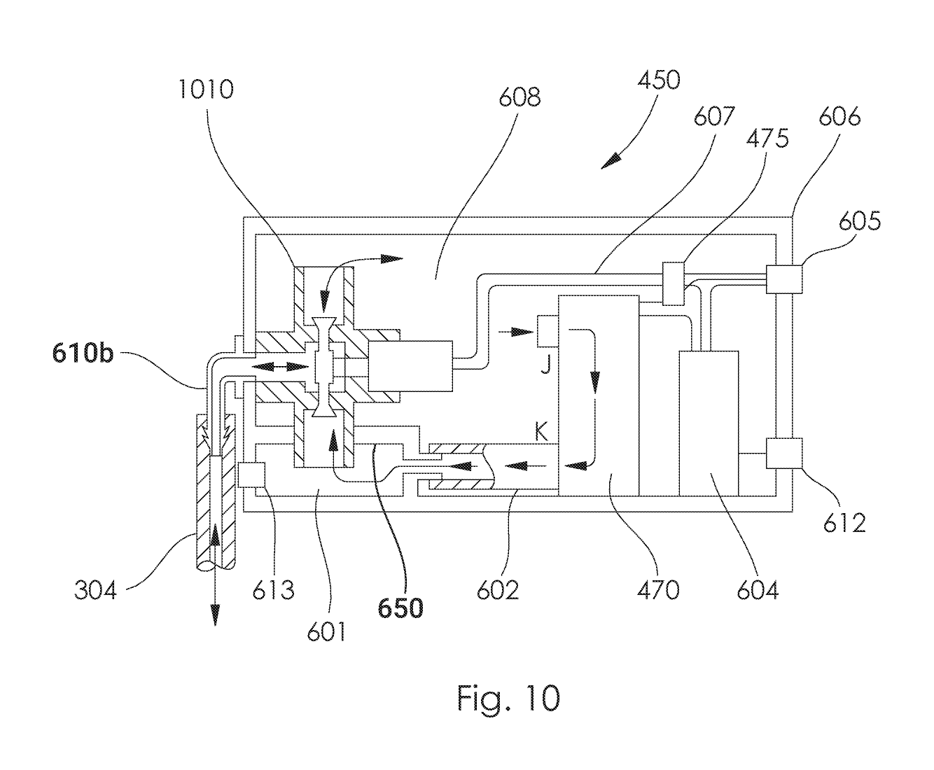

Referring now to FIGS. 9 and 10, views of an embodiment of an air pump and valve assembly 450 of the invention comprising a first plenum 601 and second plenum 608 are depicted. The first port of each of valves 1010, 1011 and 1012 are each in fluid communication with a first plenum 601 formed, for example, by an enclosed chamber in housing 606. The first plenum 601 is shown in cross section in FIG. 10. The second port of each of valves 1010, 1011 and 1012 are each in fluid communication with a second plenum 608 formed by enclosed housing 606. The third port of valve 1012 is in fluid communication with a first set of bladders, namely upper left side bladder 100 and lower left side bladder 200 (not shown in FIG. 9, but shown in FIG. 1b; and likewise the third port of valve 1010 is in fluid communication with a second set of bladders, namely upper right side bladder 102 and lower right side bladder 202 (not shown in FIG. 9, but shown in FIG. 1c. The third port of valve 1011 is in fluid communication with the environment outside pump and valve assembly 450 through filter 611, which may be an air filter in the case in which the fluid being used to fill the bladders of the invention is air. The output port K of pump 470 is in fluid communication with first plenum 601, for example through fluid tubing 602. The input port (J) 603 of fluid pump 470 is in fluid communication with the second plenum 608. Valves 1010, 1011, and 1012, and fluid pump 470, may be in electrical communication with power supply 604 and with processor 475 via electrical wiring 607, which may in turn be in electrical wired communication with an external controller 500 through electrical connector 605. Alternatively, processor 475 may be in wireless communication with an external controller 700 for receiving command inputs from a user. Third valve 1012 may be in fluid communication the first set of bladders though fluid connector 610a, and likewise first valve 1010 may be in fluid communication with the second set of bladders though fluid connector 610b. Switch 612 is in electrical communication with power supply 604 in order to command pump and valve assembly 450 into a powered or depowered state, and non-transitory computer readable media 477 is in electrical communication with processor 475. The edges of L-shaped bracket 650 are in contact with interior surfaces of housing 606, forming an enclosed volume that forms first plenum 601. Second plenum 608, which is formed of the remaining enclosed volume of housing 606, is separated from first plenum 601 by L-shaped bracket 650.

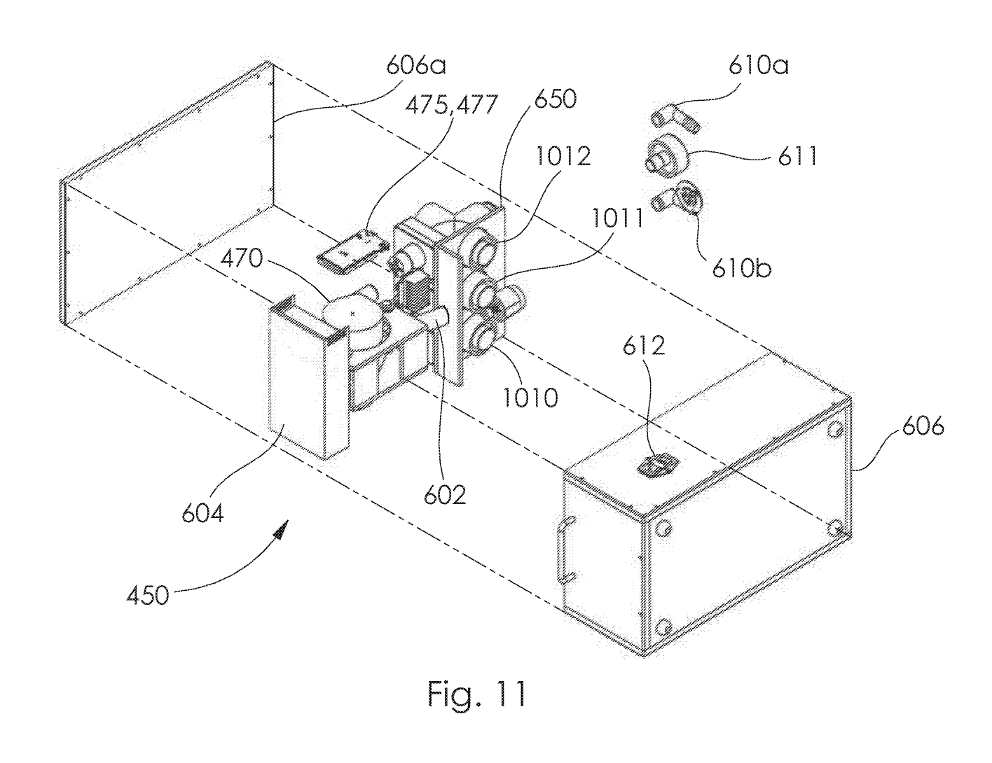

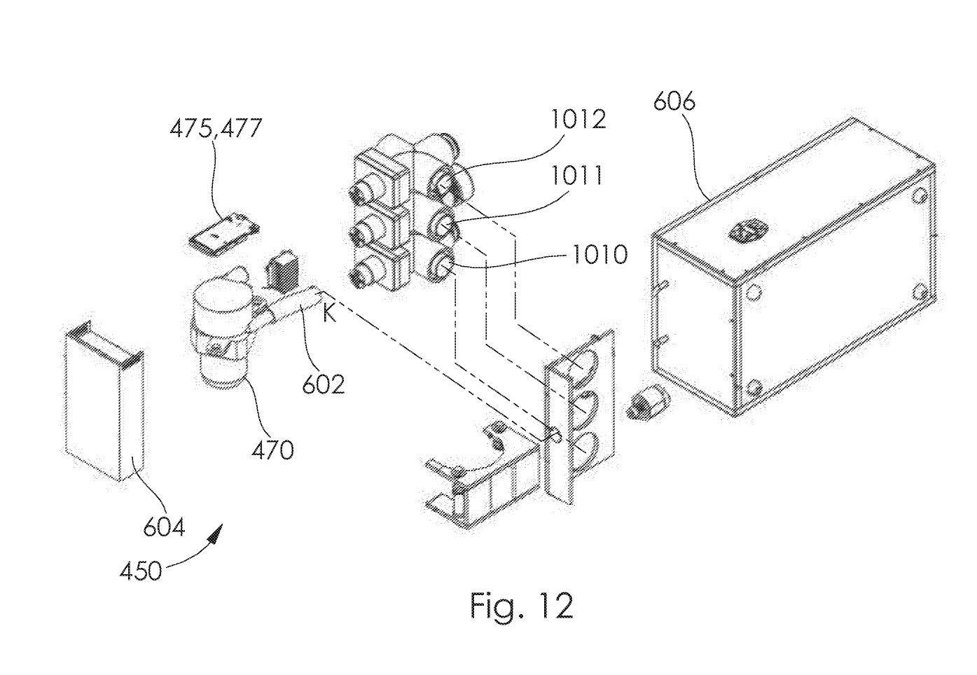

Referring now to FIGS. 11 and 12, perspective exploded views of one exemplary embodiment of a plenum version of the pump and valve assembly of the invention is depicted. Housing 606 may have a removable housing cover 606a that allows access to the internal components of this embodiment of the pump and valve assembly 450. The first port of each of valves 1010, 1011 and 1012 are shown protruding through the L-shaped shelf 650 that forms a portion of the enclosure that creates first plenum 601. Pump 470 is depicted, and the output port of pump 470 is shown in fluid communication with the L-shaped shelf 650 that forms a portion of the enclosure that creates first plenum 601 through fluid tubing 602. Processor 475 and non-transitory computer readable memory 477 may be attached to a surface within housing 606, as is power supply 604. Fluid connectors 610a and 610b and filter 611 are attached to wall of housing 606. When cover 606a is removably attached to housing 606, a complete enclosure is created which comprises first plenum 601 and second plenum 608. First plenum 601 and second plenum 608 are separated by L-shaped bracket 650, which is in contact with interior surfaces of enclosure 606 along all of its edges, forming the two plenums. Switch 612, filter 611, and fluid connectors 610a and 610b are shown for reference.

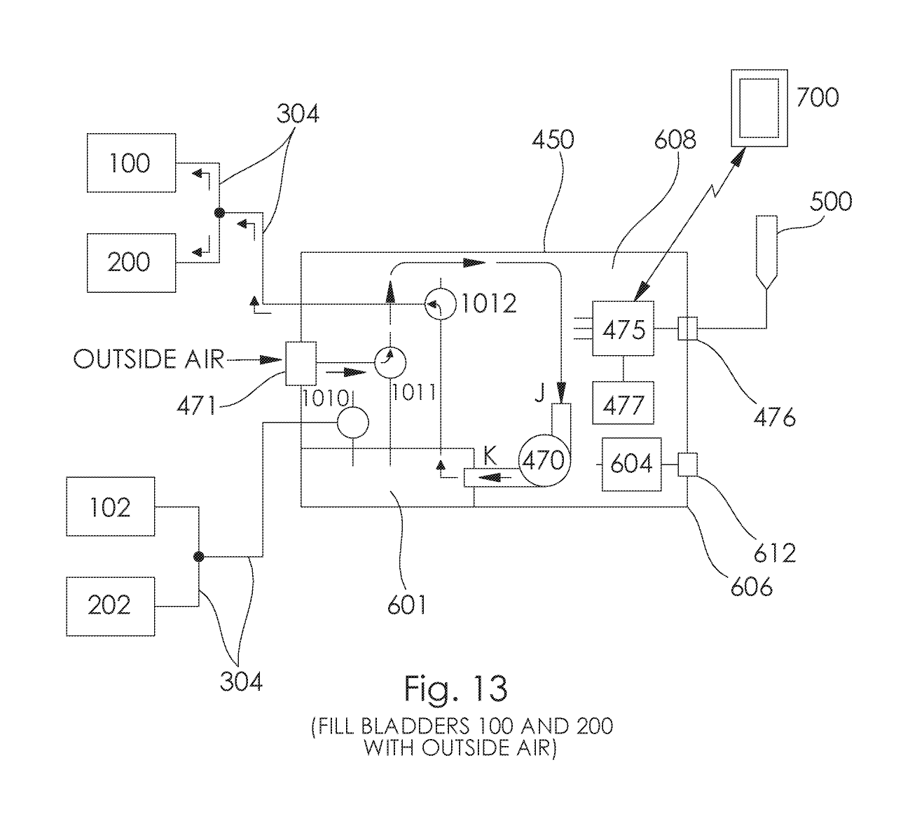

FIGS. 13-17 depict the operation of the plenum embodiment of pump and valve assembly 450.

Referring now to FIG. 13, when it is desired to inflate the first set of bladders comprising upper left side bladder 100 and lower left side bladder 200, first valve 1010 is commanded to the OFF state; second valve 1011 is commanded to allow fluid communication between the outside environment, which may be outside air, and second plenum 608; third valve 1012 is commanded to allow fluid communication between first plenum 601 and the first set of bladders; and pump 470 is commanded to an ON state causing it to pump air in a direction as depicted by the arrows of the figure. It can thus be seen that, in this condition, fluid is pulled from the outside environment, through optional filter 471, through second valve 1011, into second plenum 608, through fluid pump 470 into first plenum 601, through third valve 1012 and into the first set of bladders. Once the desired inflation pressure, for example between 0.7 and 1.0 p.s.i. relative to atmospheric pressure exterior to the bladders, is reached in the first set of bladders, all valves are commanded into the OFF state, and fluid pump 470 is commanded OFF. The valve and fluid pump commands may be electrical signals communicated from processor 475, which may be in electrical communication with external controller 500 through electrical connector 476, or may be in wireless communication with an external controller 700. The first and second plenums may be enclosed volumes in housing 606 forming a part of fluid pump and valve assembly 450. Fluid tubing 304 may provide a fluid communication path between the first and second set of bladders and valves 1012 and 1010, respectively.

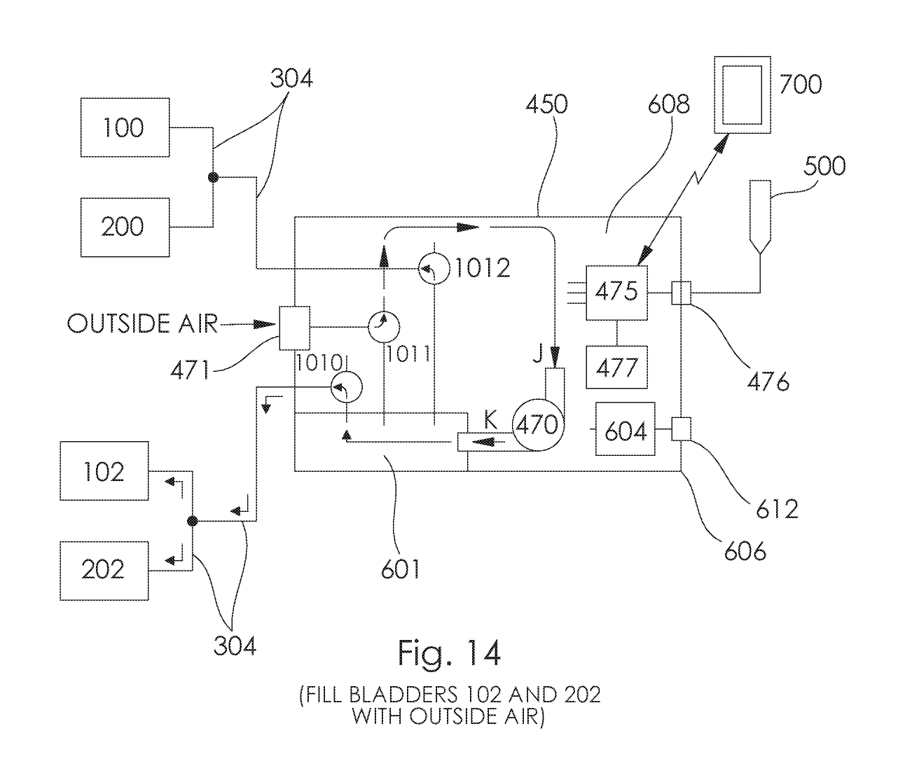

Referring now to FIG. 14, when it is desired to inflate the second set of bladders comprising upper right side bladder 102 and lower left side bladder 202, first valve 1010 is commanded to allow fluid communication between first plenum 601 and the second set of bladders; second valve 1011 is commanded to allow fluid communication between the outside environment, which may be outside air, and second plenum 608; third valve 1012 is commanded to an OFF state; and pump 470 is commanded to an ON state causing it to pump air in a direction as depicted by the arrows of the figure. It can thus be seen that, in this condition, fluid is pulled from the outside environment, through optional filter 471, through second valve 1011, into second plenum 608, through fluid pump 470 into first plenum 601, through first valve 1010 and into the second set of bladders. Once the desired inflation pressure is reached in the second set of bladders, all valves are commanded into the OFF state, and fluid pump 470 is commanded OFF. The valve and fluid pump commands may be electrical signals communicated from processor 475, which may be in electrical communication with external controller 500 through electrical connector 476, or may be in wireless communication with an external controller 700. The first and second plenums may be enclosed volumes in housing 606 forming a part of fluid pump and valve assembly 450. Fluid tubing 304 may provide a fluid communication path between the first and second set of bladders and valves 1012 and 1010, respectively.

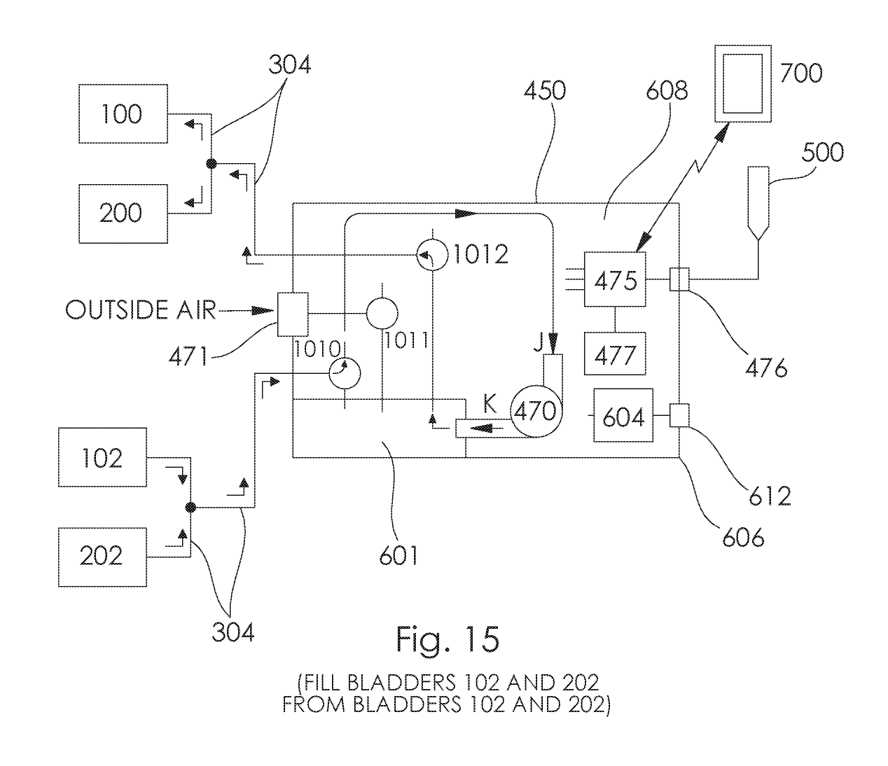

Referring now to FIG. 15, when the second set of bladders is in an inflated state and it is desired to inflate the first set of bladders comprising upper right side bladder 100 and lower left side bladder 200 by evacuating fluid from the second set of bladders to the first set of bladders such as may be desired when turning a user upon a mattress, first valve 1010 is commanded to allow fluid communication between the second set of bladders and second plenum 608; second valve 1011 is commanded to an OFF state; third valve 1012 is commanded allow fluid communication between first plenum 601 and the first set of bladders; and pump 470 is commanded to an ON state causing it to pump air in a direction as depicted by the arrows of the figure. It can thus be seen that, in this condition, fluid is pulled from the second set of bladders, through first valve 1010, into second plenum 608, through fluid pump 470 into first plenum 601, through third valve 1012 and into the first set of bladders. Once the desired inflation pressure is reached in the first set of bladders, all valves are commanded into the OFF state, and fluid pump 470 is commanded OFF. The valve and fluid pump commands may be electrical signals communicated from processor 475, which may be in electrical communication with external controller 500 through electrical connector 476, or may be in wireless communication with an external controller 700. The first and second plenums may be enclosed volumes in housing 606 forming a part of fluid pump and valve assembly 450. Fluid tubing 304 may provide a fluid communication path between the first and second set of bladders and valves 1012 and 1010, respectively.

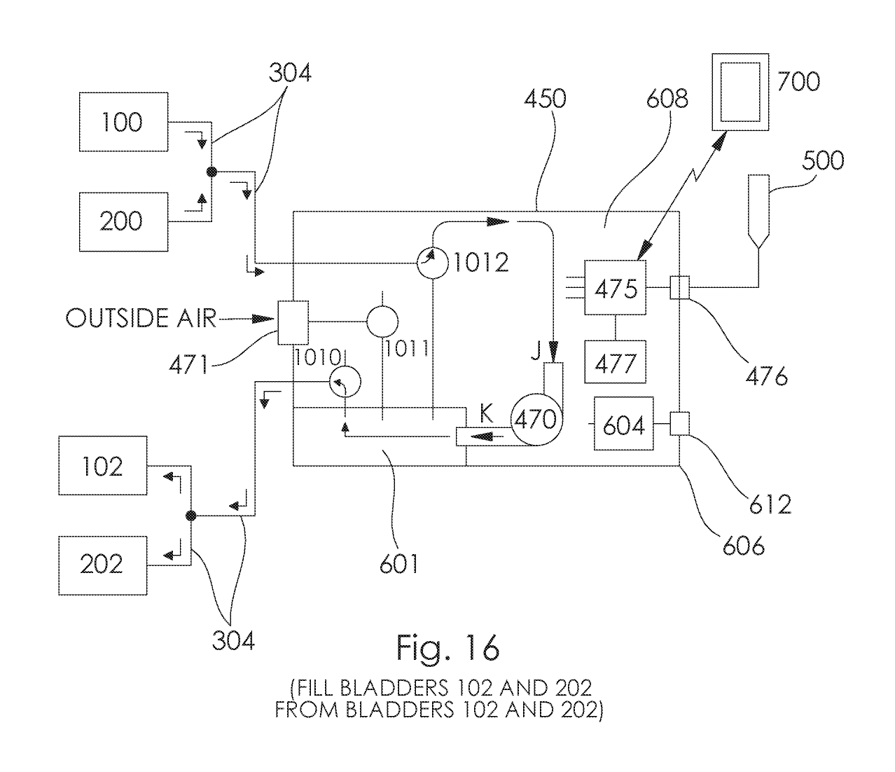

Referring now to FIG. 16, when the first set of bladders is in an inflated state and it is desired to inflate the second set of bladders comprising upper right side bladder 102 and lower right side bladder 202 by evacuating fluid from the first set of bladders to the second set of bladders such as may be desired when turning a user upon a mattress, first valve 1010 is commanded to allow fluid communication between first plenum 601 and the second set of bladders; second valve 1011 is commanded to an OFF state; third valve 1012 is commanded allow fluid communication between the first set of bladders and second plenum 608; and pump 470 is commanded to an ON state causing it to pump air in a direction as depicted by the arrows of the figure. It can thus be seen that, in this condition, fluid is pulled from the first set of bladders, through third valve 1012, into second plenum 608, through fluid pump 470 into first plenum 601, through first valve 1010 and into the second set of bladders. Once the desired inflation pressure is reached in the second set of bladders, all valves are commanded into the OFF state, and fluid pump 470 is commanded OFF. The valve and fluid pump commands may be electrical signals communicated from processor 475, which may be in electrical communication with external controller 500 through electrical connector 476, or may be in wireless communication with external controller 700. The first and second plenums may be enclosed volumes in housing 606 forming a part of fluid pump and valve assembly 450. Fluid tubing 304 may provide a fluid communication path between the first and second set of bladders and valves 1012 and 1010, respectively.

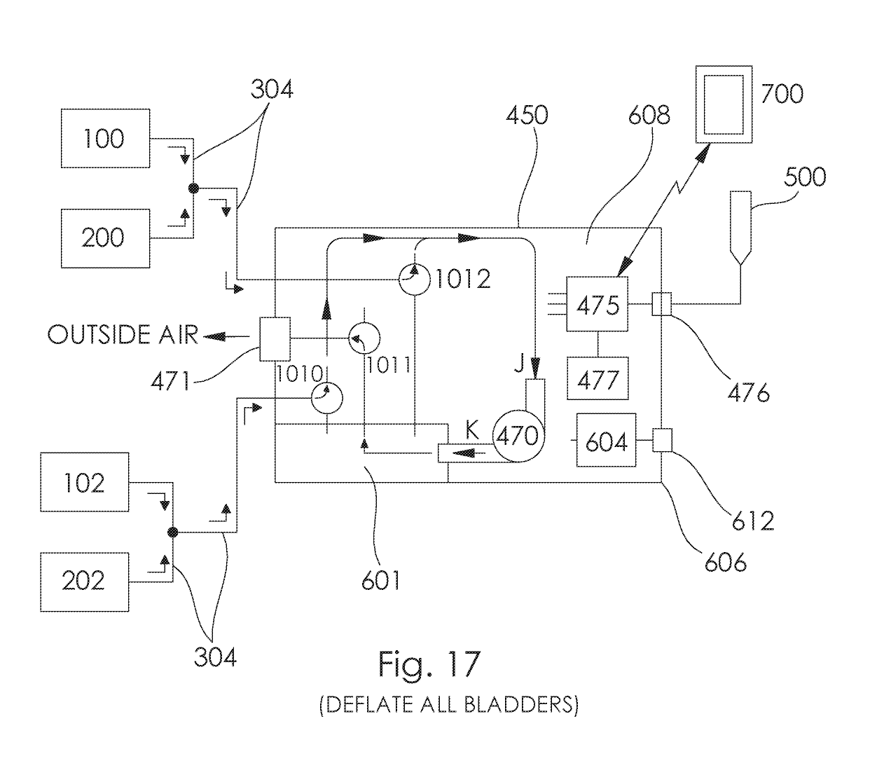

Referring now to FIG. 17, when it is desired to deflate either or both of the first or second sets of bladders, such as may be desired when a user wishes to lie flat on a bed, first valve 1010 is commanded to allow fluid communication between the second set of bladders and second plenum 608; second valve 1011 is commanded to allow fluid communication between first plenum 601 and the outside environment; third valve 1012 is commanded allow fluid communication between the first set of bladders and second plenum 608; and pump 470 is commanded to an ON state causing it to pump air in a direction as depicted by the arrows of the figure. It can thus be seen that, in this condition, fluid is pulled from the first set of bladders, through third valve 1012, into second plenum 608, and likewise fluid is pulled from the second set of bladders, through first valve 1010, into second plenum 608; fluid is then pumped from second plenum 608 through fluid pump 470 into first plenum 601, through second valve 1011 and into the environment outside pump and valve housing 606. Once the desired deflation is reached in the first set and second set of bladders, all valves are commanded into the OFF state, and fluid pump 470 is commanded OFF. The valve and fluid pump commands may be electrical signals communicated from processor 475, which may be in electrical communication with external controller 500 through electrical connector 476, or may be in wireless communication with an external controller 700. The first and second plenums may be enclosed volumes in housing 606 forming a part of fluid pump and valve assembly 450. Fluid tubing 304 may provide a fluid communication path between the first and second set of bladders and valves 1012 and 1010, respectively.

While a pneumatic embodiment of the invention is described herein, it is to be understood that hydraulic and all other fluid equivalents of the described and claimed invention are within the scope of the invention. For the pneumatic embodiment of the invention, any range of fluid pressure desired by a user may be utilized, but a typical range of bladder pressure is 0.7 pounds per square inch (p.s.i.) to 1.0 p.s.i.

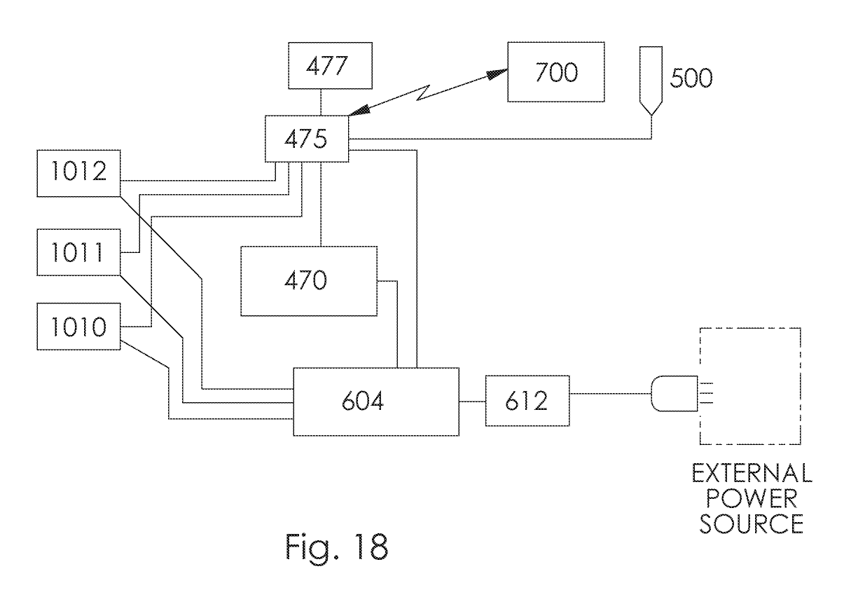

Referring now to FIG. 18, an exemplary electrical block diagram of the air mattress turning device is depicted. Power supply 604 may be in electrical communication with an external source of power, such as battery power, house current, or any other source of electrical power, through switch 612. Switch 612 may be utilized to open the electrical connection between power supply 604 and the external power source, or may be wired so as to command the outputs of power supply 604 into an OFF state in which no electrical power is delivered to valves 1010, 1011, 1012; processor 475; non-transitory computer readable memory 477; or pump 470. Power supply 604 may condition the power provided by the external power source so that it is usable by valves 1010, 1011, 1012; processor 475; non-transitory computer readable memory 477; and pump 470. The outputs of power supply 604 may be in electrical connection with valves 1010, 1011, 1012; processor 475; non-transitory computer readable memory 477; and pump 470 through electrical wiring, thus providing conditioned electrical power to these components. Processor 475 may be in electrical communication with valves 1010, 1011, 1012 and may provide electrical signals to each of them, independently, to command each individual valve into a first state, a second state, or a third state as hereinbefore described. Processor 475 may receive user commands from external user device 700 by wireless communication, or may receive user commands from external wired controller 500. Commands received by processor 475 may be used as inputs for executing computer readable instructions stored in non-transitory computer readable memory 477 for the purposes of generating control signals for operating valves 1010, 1011, 1012 and pump 470. Processor 475 may read the non-transitory computer readable instructions stored in memory 475 and execute the instructions to generate and communicate control signals to operate valves 1010, 1011, 1012 and pump 470.

In any embodiment, a user may manually input commands, or the processor 475 may execute computer readable instructions, for causing the pump(s) and valves of the invention to inflate the first set of bladders while deflating the second set of bladders, thus turning a user lying upon the invention in a first direction; and likewise the processor may execute computer readable instructions for causing the pump(s) and valves of the invention to inflate the first set of bladders while deflating the second set of bladders, thus turning a person lying upon the invention in a second direction. The turning of a person in the first direction and second direction may be programmed to occur automatically, at predetermined times. In a typical use scenario, a person may initially, in a first step, lie in a flat position upon the invention while both sets of bladders are in a deflated condition as depicted in FIG. 1a. In a second step, the bladders comprising the first set of bladders may be caused to inflate by operation of the pump(s) and valves of the invention, resulting in the person being turned in a first direction to a position as depicted in FIG. 1b, thereby relieving pressure on areas of the person's body which were previously experiencing pressure. When it is desired to turn the person in a second direction, the bladders of the first set of bladders are deflated and the bladders comprising the second set of bladders are inflated, causing the person to turn in a second direction as shown in FIG. 1c. The timing of the turning may be any timing the person desires, which may be ad hoc, or may be pre-determined by entering commands into external controller 500 or 700, whereby the commands are communicated to processor 475 and stored as non transitory computer readable instructions in computer readable media 477. Thus the turning of a person into a first position or second position, or into a flat position, may be commanded at any time or may be programmed to occur automatically at any predetermined timing. For example, the invention may be programmed by user to start from a flat state, transition into the first state after T1 minutes, transition to the second state after T2 minutes, and then transition into the flat state after T3 minutes. Times T1, T2, and T3 may independently take any value desired by the user such as five minutes, ten minutes, fifteen minutes, and so on. The invention may be programmed to transition from any state to any other state, in any sequence desired by the user, at any time interval desired by the user. Once initiated, the invention may continue to cycle through state transitions until the invention is commanded to cease by the user or the invention is powered off.

While specific embodiments of the invention are described herein, it is within the scope of the invention that the claimed embodiments include not only the embodiments shown and described, but also include all other equivalent structures and methods that would be known to a person of ordinary skill in the art.

### INDUSTRIAL APPLICABILITY

The present invention overcomes the shortcomings of the prior art in that it provides an economic, effective, pneumatically or hydraulically driven apparatus and method for turning a person in bed without assistance from another person or equipment in order to prevent the development or worsening of bed sores, also known as pressure ulcers. The apparatus and method of the invention provide a significant advancement in the state of the art, prevents bed sores and pressure ulcers, allow proper alignment of a user's spine while bed-ridden, would allow a person using the apparatus and method of the invention to turn themselves as desired without needing assistance from another person. The present invention is adapted to be used on top of a user's traditional mattress so that mattress replacement is not required when using the apparatus and method of the invention, allowing the user to continue use of the mattress of his or her choice.

The invention comprises inflatable bladders that may be filled with a fluid such as compressed air in such a manner as to inflate, causing a user's body to be rotated from an initial position to a rotated position. When deflated, the bladders of the invention may remain disposed on a top surface of the user's mattress and allow the user to experience the firmness of the mattress while the user is resting. The bladders of the invention may comprise a pair of left side bladders and a pair of right side bladders which are independently inflatable. When it is desired to turn a user, it is first determined in direction rotation of the user is desired. The bladders upon the opposite side of the mattress are then inflated, lifting the user and rotating the user's body onto the opposing side of the mattress. The bladders upon the side of the mattress upon which the user was originally lying may then be deflated. The process may be repeated in reverse when it is desired to turn the user back on to the side of the mattress upon which the user was originally lying. In this manner, the user may be turned from one side of a mattress to an opposing side of the mattress and vice versa, as desired.

The invention further comprises a pump and valve assembly, in which the valves are diverter valves, and the pump is a low pressure pump. The pump and valve assembly is useful for selective directing a fluid, which may for example be air, to be pumped to an external receiving structure such as a bladder or plurality of bladders. The pump and valve assembly is remotely controllable and may be programmed to inflate or deflate specific bladders or sets of bladders on a predetermined schedule. The pump and valve assembly may be in wireless or wired communication with an external controller such as a cell phone, personal computer, electronic tablet or other electronic device. The wireless communication may be direct or may be indirect, as through a wireless data router that is in data communication with the internet.

The invention is thus applicable to the industry of patient healthcare, especially for reducing the risk of bed sores in patients that may be bed ridden and who are at increased risk of developing such bed sores.

What is claimed is:

1. An apparatus for turning a person, comprising:
a first set of bladders comprising at least one inflatable bladder having an interior volume;
a second set of bladders comprising at least one inflatable bladder having an interior volume; and
at least one fluid pump;
wherein said first set of bladders is disposed adjacent to said second set of bladders; and
wherein said first set of bladders is in fluid communication with said at least one fluid pump through a first fluid valve and is inflatable or deflatable by operation of said at least one fluid pump and said first fluid valve to motivate a fluid into said interior volume of said at least one bladder of said first set of bladders; and
wherein said second set of bladders is in fluid communication with said at least one fluid pump through a second fluid valve and is inflatable or deflatable by operation of said at least one fluid pump and said second fluid valve to motivate fluid into said interior volume of said at least one bladder of said first set of bladders; and
wherein said at least one pump, said first fluid valve, and said second fluid valve are all controllable by a user, allowing independent inflation and deflation of each of said first set of bladders and said second set of bladders.

2. The apparatus of claim 1, wherein:
the first set of bladders is further defined as comprising first bladder and a second bladder, the first bladder being disposed upon the second bladder; and
the second set of bladders is further defined as a comprising a third bladder and a fourth bladder, the first bladder being disposed upon the second bladder;
wherein the first and second bladders are in fluid communication; and
the third and fourth bladders are in fluid communication.

3. The apparatus of claim 2, wherein the fluid is further defined as air.

4. The apparatus of claim 2, further comprising a processor in electrical communication with each of said at least one pump, said first valve, and said second valve, wherein said processor executes non-transitory computer readable instructions for commanding said at least one pump, said first valve, and said second valve to cause the first set of bladders to be inflated or to deflated, resulting a flat state in which no sets of bladders are inflated, in a first state in which only the bladders comprising first set of bladders are inflated, or in a second state in which only the bladders comprising the second set of bladders are inflated.

5. The apparatus of claim 4, wherein said processor is in electrical communication with a computer readable media, and wherein said computer readable media stores said non transitory computer readable instructions for commanding said at least one pump, said first valve, and said second valve.

6. The apparatus of claim 4, wherein said processor is in wireless or wired communication with an external controller, and wherein said external controller is adapted to receive user commands for causing the at least one pump and air valves to result in the first and second set of bladders to be in said flat state, said first state, or said second state.

7. The apparatus of claim 4, wherein said processor is in wireless or wired communication with an external controller, and wherein said external controller is adapted to receive user commands for causing the at least one pump and air valves to result in the first and second set of bladders to be in said flat state, said first state, or said second state.

8. The apparatus of claim 4, wherein said fluid is further defined as air.

9. The apparatus of claim 6, wherein said fluid is further defined as air.

10. The apparatus of claim 8, wherein the air pressure within the bladders comprising the first set of bladders, and the air pressure within the second set of bladders, when inflated, is not more than one pound per square inch greater than the environment air pressure outside the bladder.

11. The apparatus of claim 9, wherein the air pressure within the bladders comprising the first set of bladders, and the air pressure within the second set of bladders, when inflated, is not more than one pound per square inch greater than the environment air pressure outside the bladder.

12. The apparatus of claim 2, further comprising a third fluid valve, and wherein said each of
said first, second and third fluid valves are enclosed within a housing and are further defined as a diverter valves having a first port, a second port, and a third port; each fluid valve having a first state, second state and a third state; and wherein each of said at least one valves is individually controllable to a either said first state, said second state, or said third state; and wherein, for each valve:
said first state allows fluid communication between said valve first port and said valve third port, allowing a fluid to pass between said first port and said third port, and there is no fluid communication between said second port and said third port; and
said second state allows fluid communication between said valve second port and said third port, allowing a fluid to pass between said second port and said third port, and there is no fluid communication between said first port and said third port; and
said third state does not allow communication between any of the first, second or third valve ports; and wherein each of said fluid valve first ports are in fluid communication with one another through a first plenum formed by a first enclosed volume within said housing;
all of said valve third ports are in fluid communication through a through a second plenum formed by a second enclosed volume within said housing;
said second port of said first valve is in fluid communication with said first set of bladders;
said second port of said third valve is in fluid communication with said second set of bladders;
and said second port of said second valve is in fluid communication with an environment external to said housing.

13. The apparatus of claim 12, further comprising a processor in electrical communication with each of said at least one pump, said first fluid valve, said second fluid valve, and said third fluid valve wherein said processor executes non-transitory computer readable instructions for commanding said at least one pump, said first fluid valve, and said second fluid valve and said third fluid valve to cause the first set of bladders to be inflated or to deflated, resulting a flat state in which no sets of bladders are inflated, in a first state in which only the bladders comprising first set of bladders are inflated, or in a second state in which only the bladders comprising the second set of bladders are inflated.

14. The apparatus of claim 13, wherein said processor is in electrical communication with a computer readable media, and wherein said computer readable media stores said non transitory computer readable instructions for commanding said at least one pump, said first valve, said second valve, and said third fluid valve.

15. The apparatus of claim 13, wherein said processor is in wireless or wired communication with an external controller, and wherein said external controller is adapted to receive user commands for controlling the at least one pump and said first valve, said second valve, and said third fluid valve to cause the first and second set of bladders to be in said flat state, said first state, or said second state.

16. The apparatus of claim 13, wherein said processor is in wireless or wired communication with an external controller, and wherein said external controller is adapted to receive user commands for controlling the at least one pump and said first valve, said second valve, and said third fluid valve to cause the first and second set of bladders to be in said flat state, said first state, or said second state.

17. The apparatus of claim 13, wherein said fluid is further defined as air.

18. The apparatus of claim 15, wherein said fluid is further defined as air.

19. The apparatus of claim 17, wherein the air pressure within the bladders comprising the first set of bladders, and the air pressure within the second set of bladders, when inflated, is not more than one pound per square inch greater than the environment air pressure outside the bladder.

20. The apparatus of claim 18, wherein the air pressure within the bladders comprising the first set of bladders, and the air pressure within the second set of bladders, when inflated, is not more than one pound per square inch greater than the environment air pressure outside the bladder.

21. A pump and valve assembly, comprising: comprising a first fluid valve, a second fluid valve, and a third fluid valve, wherein said each of said first, second and third fluid valves are enclosed within a housing and are further defined as a diverter valves having a first port, a second port, and a third port; each fluid valve having a first state, second state and a third state; and wherein each of said at least one valves is individually controllable to a either said first state, said second state, or said third state; and wherein, for each valve:
said first state allows fluid communication between said valve first port and said valve third port, allowing a fluid to pass between said first port and said third port, and there is no fluid communication between said second port and said third port; and
said second state allows fluid communication between said valve second port and said third port, allowing a fluid to pass between said second port and said third port, and there is no fluid communication between said first port and said third port; and
said third state does not allow communication between any of the first, second or third valve ports; and wherein each of said fluid valve first ports are in fluid communication with one another through a first plenum formed by a first enclosed volume within said housing;
all of said valve third ports are in fluid communication through a through a second plenum formed by a second enclosed volume within said housing;
said second port of said first valve is in fluid communication with said first set of bladders;
said second port of said third valve is in fluid communication with said second set of bladders; and
said second port of said second valve is in fluid communication with an environment external to said housing.

22. The apparatus of claim 21, further comprising a processor in electrical communication with each of said at least one pump, said first fluid valve, said second fluid valve, and said third fluid valve wherein said processor executes non-transitory computer readable instructions for commanding said at least one pump, said first fluid valve, and said second fluid valve and said third fluid valve to cause the first set of bladders to be inflated or to deflated, resulting a flat state in which no sets of bladders are inflated, in a first state in which only the bladders comprising first set of bladders are inflated, or in a second state in which only the bladders comprising the second set of bladders are inflated.

23. The apparatus of claim 22, wherein said processor is in electrical communication with a computer readable media, and wherein said computer readable media stores said non transitory computer readable instructions for commanding said at least one pump, said first valve, said second valve, and said third fluid valve.

24. The apparatus of claim 22, wherein said processor is in wireless or wired communication with an external controller, and wherein said external controller is adapted to receive user commands for controlling the at least one pump and said first valve, said second valve, and said third fluid valve to cause the first and second set of bladders to be in said flat state, said first state, or said second state.

25. The apparatus of claim 22, wherein said processor is in wireless or wired communication with an external controller, and wherein said external controller is adapted to receive user commands for controlling the at least one pump and said first valve, said second valve, and said third fluid valve to cause the first and second set of bladders to be in said flat state, said first state, or said second state.

26. A method for rotating a person to prevent bed sores, comprising the steps of:
providing a first set of bladders comprising at least one inflatable bladder;
providing a second set of bladders comprising at least one inflatable bladder;
wherein said first set of bladders is disposed adjacent to said second set of bladders placing a person in a supine position on said first set of bladders and said second set of bladders so that a portion of the person's body is disposed on said first set of bladders, and a portion of the person's body disposed upon said second set of bladders, when each of said first and second set of bladders are deflated in a flat position; and
rotating said person into a first position by inflating said first set of bladders with a fluid while said second set of bladders is deflated, causing the person to be rotated into a first position;
rotating said person into a second position by inflating said second set of bladders with a fluid while said first set of bladders is deflated, causing the person to be rotated into a first position; and
rotating said person into a supine position by causing fluid to be removed from both of said first set of bladders and said second set of bladders, causing both of said first set of bladders and said second set of bladders to be in a flat position.

27. The method of claim 26, wherein the first set of bladders and said second set of bladders are disposed upon a mattress.

28. The method of claim 26, wherein said fluid is air.

29. The method of claim 28, wherein the air pressure within the bladders comprising the first set of bladders, and the air pressure within the second set of bladders, when inflated, is not more than one pound per square inch greater than the environment air pressure outside the bladder.

30. The method of claim 26, wherein said rotation of a person into a first position, second position, or a supine position may take any order.

31. The method of claim 26, wherein
said first set of bladders is in fluid communication with said at least one fluid pump through a first fluid valve and is inflatable or deflatable by operation of said at least one fluid pump and said first fluid valve to motivate fluid into said interior volume of said at least one bladder of said first set of bladders; and
wherein said second set of bladders is in fluid communication with said at least one fluid pump through a second fluid valve and is inflatable or deflatable by operation of said at least one fluid pump and said second fluid valve to motivate fluid into said interior volume of said at least one bladder of said first set of bladders; and
wherein said at least one pump, said first fluid valve, and said second fluid valve are all controllable by a user, allowing independent inflation and deflation of each of said first set of bladders and said second set of bladders.

32. The method of claim 31 wherein the first set of bladders is further defined as comprising first bladder and a second bladder, the first bladder being disposed upon the second bladder; and
the second set of bladders is further defined as a comprising a third bladder and a fourth bladder, the first bladder being disposed upon the second bladder;
wherein the first and second bladders are in fluid communication; and
the third and fourth bladders are in fluid communication.

33. The method of claim 32 further defined as a processor being in electrical communication with each of said at least one pump, said first valve, and said second valve, wherein said processor executes non-transitory computer readable instructions for commanding said at least one pump, said first valve, and said second valve to cause the first set of bladders to be inflated or to deflated, resulting said person being in sad flat state in which no sets of bladders are inflated, in a first state in which only the bladders comprising first set of bladders are inflated, or in a second state in which only the bladders comprising the second set of bladders are inflated.

34. The method of claim 33, wherein said processor is in electrical communication with a computer readable media, and wherein said computer readable media stores said non transitory computer readable instructions for commanding said at least one pump, said first valve, and said second valve.

35. The method of claim 34, wherein said processor is in wireless or wired communication with an external controller, and wherein said external controller is adapted to receive user commands for causing the at least one pump and air valves to result in the first and second set of bladders to be in said flat state, said first state, or said second state.

36. The method of claim 35, wherein the turning of said person into one of a flat position, a first position, or a second position is caused to occur in any order, and wherein each turning of said person is caused to occur at a predetermined time without command by the person, wherein said turning is caused by operation of said processor executing non transitory computer readable instructions to control said at least one pump, said first valve, and said second valve to cause said turning.

37. The method of claim 31, wherein said fluid is air.

38. The method of claim 37, wherein the air pressure within the bladders comprising the first set of bladders, and the air pressure within the second set of bladders, when inflated, is not more than one pound per square inch greater than the environment air pressure outside the bladder.
